(19) United States
(12) Patent Application Publication
(10) Pub. No.: US 2020/0411879 A1
(43) Pub. Date: Dec. 31, 2020

(54) LOW COST AIR ELECTRODES

(71) Applicant: FORM ENERGY INC.,, Somerville, MA (US)

(72) Inventors: Katherine HARTMAN, Cambridge, MA (US); Kristen CARLISLE, Medford, MA (US); Jarrod David MILSHTEIN, Cambridge, MA (US); Liang SU, Medfield, MA (US); Rupak CHAKRABORTY, Brookline, MA (US); Yet-Ming CHIANG, Weston, MA (US); Thomas JARAMILLO, Menlo Park, CA (US); William Henry WOODFORD, Cambridge, MA (US); Marco FERRARA, Boston, MA (US); Mateo Cristian JARAMILLO, San Francisco, CA (US); Theodore Alan WILEY, Somerville, MA (US); Erick RUOFF, Boston, MA (US); Nicholas Reed PERKINS, Cambridge, MA (US); Marc-Antoni GOULET, Somerville, MA (US); Joycelyn NEWHOUSE, Somerville, MA (US); Andrew Haynes LIOTTA, Cambridge, MA (US); Bradley MILESON, Boston, MA (US); Michael Andrew GIBSON, Philadelphia, PA (US); Eric WEBER, Pittsburgh, PA (US); Annelise Christine THOMPSON, Medford, MA (US)

(21) Appl. No.: 16/913,958

(22) Filed: Jun. 26, 2020

Related U.S. Application Data
(60) Provisional application No. 62/868,540, filed on Jun. 28, 2019.
(60) Provisional application No. 63/013,864, filed on Apr. 22, 2020.
(60) Provisional application No. 63/021,262, filed on May 7, 2020.

(51) Int. Cl. H01M 4/86; H01M 4/92; H01M 4/96; H01M 4/90; H01M 4/88

(52) U.S. Cl. CPC H01M 4/8615; H01M 4/8621; H01M 4/921; H01M 4/8853; H01M 4/9016; H01M 4/8657; H01M 4/8668; H01M 4/96

(57) ABSTRACT

Systems and methods of the various embodiments may provide low cost bifunctional air electrodes. Various embodiments may provide a bifunctional air electrode, including a metal substrate and particles of metal and/or metal oxide catalyst and/or metal nitride catalyst coated on the metal substrate. Various embodiments may provide a bifunctional air electrode, including a first portion configured to engage an oxygen reduction reaction (ORR) in a discharge mode and a second portion configured to engage an oxygen evolution reaction (OER) in a charge mode. Various embodiments may provide a method for making an air electrode including coating a metal substrate with particles of metal and/or metal oxide catalyst and/or metal nitride catalyst. Various embodiments may provide batteries including air electrodes.

### RELATED APPLICATIONS

This application claims the benefit of priority to U.S. Provisional Patent Application No. 62/868,540 entitled “Low Cost Air Electrodes” filed Jun. 28, 2019 and U.S. Provisional Patent Application No. 63/021,262 entitled “Low Cost Air Electrodes” filed May 7, 2020 and the entire contents of both applications are hereby incorporated by reference for all purposes. This application also claims the benefit of priority to U.S. Provisional Patent Application No. 63/013,864 entitled “Porous Materials For Battery Electrodes” filed Apr. 22, 2020, the entire contents of which are hereby incorporated by reference for all purposes

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, at least ≥8 h) energy storage systems.

Electrochemical energy storage systems that utilize reversible air electrodes are attractive for long duration energy storage (LODES) systems due to the massive abundance and low cost of air as a reagent. Air electrodes for LODES will need to be much more inexpensive than air electrodes for high power electrochemical devices (e.g., fuel cells, electrolyzers, etc.). Additionally, air electrodes for LODES will undergo large potential swings and current polarity switches, which are operational characteristics that have been known to degrade many electrodes, inclusive of both substrates (alternatively called support) and catalysts for the oxygen evolution reaction (OER) and/or oxygen reduction reaction (ORR).

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems and methods of the various embodiments may provide low cost bifunctional air electrodes. Various embodiments may provide a bifunctional air electrode, including a metal substrate and particles of metal and/or metal oxide and/or metal nitride catalyst coated on the metal substrate. Various embodiments may provide a bifunctional air electrode, including a first portion configured to engage an oxygen reduction reaction (ORR) in a discharge mode and a second portion configured to engage an oxygen evolution reaction (OER) in a charge mode. Various embodiments may provide a method for making an air electrode including coating a metal substrate with particles of metal and/or metal oxide and/or metal nitride catalyst. Various embodiments may provide a battery including a first vessel, a bifunctional air electrode, a metal electrode, and a first volume of liquid electrolyte within the first vessel, wherein the first volume of liquid electrolyte separates the bifunctional air electrode from the metal electrode. Various embodiments may provide a battery including a first vessel, an ORR air electrode, an OER electrode, a metal electrode, and a first volume of liquid electrolyte within the first vessel, wherein the first volume of liquid electrolyte separates the ORR air electrode and the OER electrode from the metal electrode.

According to various embodiments of the present disclosure, provided is a bifunctional air electrode, comprising: a metal substrate; and particles of metal oxide and/or metal nitride catalyst deposited on the metal substrate. In some embodiments, the particles comprise manganese oxide (MnO₂, Mn₂O₃, Mn₃O₄, MnₓO_{y} (where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y} (where x=0 to 2 and y=0 to 3)), cobalt oxide (Co₃O₄, CoₓO_{y} (where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (e.g. La_{0.8}Sr_{0.2}MnO₃), other transition metal oxides or nitrides, or any combinations thereof.

In some embodiments, the metal substrate is a mesh, a foam, or a porous sintered solid. In some embodiments, the metal substrate comprises iron, nickel, iron-alloy, copper, aluminum, steel, carbon steel, or stainless steel. In some embodiments, the particles of metal oxide catalyst comprise manganese oxide, nickel oxide, nickel oxyhydroxide, iron oxide, iron oxyhydroxide, or mixed transition metal oxides. In some embodiments, the metal substrate comprises nickel rich iron alloy. In some embodiments, the electrode further comprises particles of metal deposited on the metal substrate. In some embodiments, the particles of metal comprise iron or nickel. In some embodiments: the metal substrate comprises iron, the particles of metal comprise nickel, and the particles of metal oxide catalyst comprise manganese oxide; the metal substrate comprises nickel, the particles of metal comprise iron, and the particles of metal oxide catalyst comprise manganese oxide; the metal substrate comprises steel, the particles of metal comprise nickel, and the particles of metal oxide catalyst comprise manganese oxide; or the metal substrate comprises steel, the particles of metal comprise iron, and the particles of metal oxide catalyst comprise manganese oxide. In further embodiments, the particles of metal nitride catalyst comprise Fe₃N, FeCN, ZrN, Mn₄N, or combinations thereof.

In some embodiments, the metal nitride catalyst is prepared by reacting Fe₂O₃ or Fe₃O₄ with ammonia in a furnace or reaction vessel. In some embodiments, the catalyst is Fe₃C. In some embodiments, the catalyst is prepared by reacting Fe₃C with ammonia in a furnace or reaction vessel.

According to various embodiments of the present disclosure, provided is a bifunctional air electrode, comprising: a first portion configured to engage an oxygen reduction reaction (ORR) in a discharge mode; and a second portion configured to engage an oxygen evolution reaction (OER) in a charge mode.

In some embodiments: the first portion comprises an ORR electrode and an ORR catalyst; and the second portion comprises an OER electrode and an OER catalyst. In some embodiments: the ORR electrode comprises carbon cloth, carbon felt, carbon paper, or a gas diffusion layer; the ORR catalyst comprises manganese oxide or platinum; the OER electrode comprises nickel, iron, stainless steel, or carbon steel; and the OER catalyst comprises manganese oxide, nickel, or iron. In some embodiments the ORR electrode and/or the OER electrode is a mesh, a foam, or a porous sintered solid. In some embodiments, the electrode further comprises a hydrophobic coating on one or both of either of the first portion and the second portion. In some embodiments, the hydrophobic coating comprises polyethylene, polyvinylidene fluoride, polytetrafluoroethylene, or polypropylene. In some embodiments, the ORR electrode comprises a carbon substrate coated with a manganese oxide catalyst. In some embodiments, the carbon substrate is a carbon cloth, a carbon felt, a carbon paper, or a gas diffusion layer. In some embodiments, the OER electrode comprises a metal substrate. In some embodiments, the metal substrate comprises titanium, nickel, iron, stainless steel, or carbon steel. In some embodiments, the metal substrate is coated with a manganese oxide catalyst, a nickel catalyst, or an iron catalyst. In some embodiments, the metal substrate comprises direct reduced iron (DRI), atomized iron powder, or sponge iron. In some embodiments, the metal substrate comprises a mesh, a foam, a sintered porous structure, or a packed bed of metal particles. In some embodiments, the metal substrate comprises a packed bed of particles comprising direct reduced iron (DRI) or sponge iron. In some embodiments, the metal substrate is in the form of a cage configured to operate as a current collector and having openings configured for electrolyte and gas flow. In some embodiments, the cage comprises iron, nickel, or a nickel-iron alloy and may take the shape of a mesh, perforated metal, woven metal or expanded metal.

In some embodiments, the substrate or cage is coated with a catalyst comprising silver, palladium, platinum, manganese oxide (MnO₂, Mn₂O₃, Mn₃O₄, MnₓO_{y} (where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₋ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides or nitrides, metallic nickel, metallic iron, or any combinations thereof.

According to various embodiments of the present disclosure, provided is a method for making an air electrode, the method comprising coating a metal substrate with particles of metal oxide and/or metal nitride catalyst.

In some embodiments, coating the metal substrate with the particles of metal oxide catalyst comprises electrodepositing or electroplating the particles of metal oxide catalyst onto the metal substrate in an acid solution. In some embodiments, the method further comprises depositing a metallic layer on the substrate prior to coating the metal substrate with the particles of metal oxide catalyst. In some embodiments, the method further comprises processing the metal substrate to increase surface area prior to coating the metal substrate with the particles of metal oxide catalyst. In some embodiments, the processing steps may include etching, oxidation and reduction, mechanical roughening, electroless plating, electrodeposition, electrochemical sintering, thermal sintering, intentional dendritic formation via electrodeposition, or any combination thereof. In some embodiments, the method further comprises depositing conductive particles onto the substrate prior to coating the metal substrate with the particles of metal oxide catalyst. In some embodiments, the deposited conductive particles are microscale conductive particles and mesoscale conductive particles. In some embodiments, the method further comprises depositing a metal onto the substrate after depositing the conductive particles and prior to coating the metal substrate with the particles of metal oxide catalyst. In some embodiments, the metal is nickel. In some embodiments, the particles of metal oxide catalyst are mesoscale particles of metal oxide catalyst and nanoscale particles of metal oxide catalyst. In some embodiments, the particles of metal oxide catalyst are particles of cobalt or manganese. In further embodiments, the particles of metal oxide catalyst are comprised of transition metal nitrides such as Fe₃N, FeCN, ZrN, Mn₄N, or combinations thereof.

According to various embodiments of the present disclosure, provided is a method for making an air electrode, the method comprising coating a metal substrate with particles of metal oxide and/or metal nitride catalyst. In some embodiments, coating the metal substrate with the particles of metal oxide and/or metal nitride catalyst comprises electrodepositing or electroplating the particles of metal oxide and/or metal nitride catalyst onto the metal substrate in an acid solution. In some embodiments, the metal and/or metal oxide and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

In some embodiments, the metal oxide catalyst comprises manganese oxide (MnO₂, Mn₂O₃, Mn₃O₄, MnₓO_{y}(where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides or nitrides (such as Fe3N, FeCN, ZrN, Mn4N, or combinations thereof), or any combinations thereof.

In some embodiments, the metal nitride catalyst is prepared by reacting Fe2O3 or Fe3O4 with ammonia in a furnace or reaction vessel. In some embodiments, the catalyst is Fe3C. In some embodiments, the catalyst is prepared by reacting Fe3C with ammonia in a furnace or reaction vessel.

According to various embodiments of the present disclosure, provided is a battery, comprising: a first vessel; a bifunctional air electrode; a metal electrode; and a first volume of liquid electrolyte within the first vessel, wherein the first volume of liquid electrolyte separates the bifunctional air electrode from the metal electrode.

In some embodiments, the battery further comprises: a switch coupled to an electrical lead; a charge lead coupled between the switch and a first portion of the bifunctional air electrode, the first portion configured to engage an oxygen reduction reaction (ORR) when the battery is operated in a discharging mode; and a discharge lead coupled to between the switch and a second portion of the bifunctional air electrode, the second portion configured to engage an oxygen evolution reaction (OER) when the battery is operated in a charging mode, wherein the switch is configured to selectively electrically connect the electrical lead to either the charge lead or the discharge lead. In some embodiments, the first portion of the bifunctional air electrode is physically separated from the second portion of the bifunctional air electrode.

According to various embodiments of the present disclosure, provided is a battery, comprising: a vessel; an oxygen reduction reaction (ORR) air electrode; an oxygen evolution reaction (OER) electrode; a metal electrode; and a first volume of liquid electrolyte within the vessel, wherein the first volume of liquid electrolyte separates the ORR air electrode and the OER electrode from the metal electrode.

In some embodiments, the battery further comprises: a first separator disposed in the vessel between the ORR air electrode and the metal electrode; and a second separator disposed in the vessel between the OER electrode and the metal electrode. In some embodiments, the ORR air electrode is positioned at an interface between air and the first volume of liquid electrolyte and the OER electrode is submerged in the first volume of liquid electrolyte.

According to various embodiments of the present disclosure, provided is a bulk energy storage system, comprising: one or more batteries, wherein at least one of the one or more batteries comprises: a first vessel; a bifunctional air electrode comprising: a first portion configured to engage an oxygen reduction reaction (ORR) when the battery is operated in a discharging mode; and a second portion configured to engage an oxygen evolution reaction (OER) when the battery is operated in a charging mode; a metal electrode; and a first volume of liquid electrolyte within the first vessel, wherein the first volume of liquid electrolyte separates the bifunctional air electrode from the metal electrode.

In some embodiments, the bifunctional air electrode further comprises: a metal substrate; and particles of metal oxide and/or metal nitride catalyst deposited on the metal substrate. In some embodiments, the particles of metal oxide and/or metal nitride catalyst comprise manganese oxide (MnO₂, Mn₂O₃, Mn₃O₄, MnₓO_{y}(where x=1 to 3 and y=1 to 8)), nickel-doped manganese oxide (Ni—MnₓO_{y} (where x=1 to 3 and y=1 to 8)), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides or nitrides (such as Fe3N, FeCN, ZrN, Mn4N, or combinations thereof), or any combinations thereof.

In some embodiments, the metal and/or metal oxide and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

In some embodiments, sulfur is introduced onto the surface of an OER electrode as a method to increase surface area and/or modify catalytic activity at the surface. The deposition of sulfur is achieved by placing the electrode into a bath of sulfur containing solution (i.e. thiourea, aqueous metal sulfates, aqueous metal sulfides), then heat treated to form a surface of crystalline or amorphous metal sulfide or bimetallic sulfide bridges. In some embodiments, surface sulfurization is achieved by annealing in a sulfur-containing gas such as hydrogen sulfide (H₂S).

In various embodiments of the OER, the substrate is formed using silica. An OER electrode substrate is first formed by creating a high-porosity low-weight framework using silica. This framework may be produced from annealed/sintered silica particles. A low-cost metal (such as iron, aluminum, or an alloy of the two) is deposited onto the pre-formed framework. In a possible additional step, a catalytic species is added. This catalyst may include iron, nickel, tungsten, copper, zinc, or some alloy of the aforementioned metals. An optional next step is to treat the now formed electrode for mechanical integrity, surface area modification, or to form a surface species.

The performance of any electrode or section of electrode operating at oxygen evolution reduction potentials hinges on high surface area and/or high porosity metallic substrates to provide ample reaction sites for OER. There may be many synthesis routes to high surface area metallic substrates. One method of engineering the pore size of an iron substrate to an acceptable size is through swelling. In some embodiments the substrate is made of a different starting metal. Iron ore can be caused to swell upon reduction in the appropriate reducing gas conditions, atmosphere (such as CO), flow rate, temperature, etc and/or with the proper pellet chemistry and additives (such as limestone). Swelling leads to a more open structure, and hence higher surface area and lower probability of pore clogging upon subsequent deposition of catalyst materials. Similarly, other metals, such as silver, have been shown to swell upon sintering. In some embodiments, powdered iron, fines, or crushed DRI are engineered to swell in the appropriate sinter conditions, possibly with the presence of a volatile additive that helps build local pressure, preventing the atoms from densifying. In either case, whether the swelling occurs during reduction or sintering, the processes ultimately increase the porosity of the metal structure without jeopardizing the mechanical integrity.

Additional methods of synthesizing highly porous, high surface area, controlled porosity metallic substrates for OER are described herein. In various embodiments, a metallic OER substrate (typically iron) is produced using roll compaction or high shear roll compaction. Iron powders or similar materials are held together using binders, then pressed using rollers (which may also apply a heat treatment). The pressed green part is then sintered to create mechanical stability and electrical conductivity between iron particles. Selection of iron powder, fugitive pore formers and binders influence final surface area and porosity. In various embodiments, a metallic OER substrate (typically iron) is produced using cold isostatic pressing (CIP) then sliced into the appropriate size electrode. In various embodiments, a metallic OER substrate (typically iron) is produced using loose powder sintering, where no pressure to compact the iron powder is applied.

### BRIEF DESCRIPTION OF THE FIGURES

The accompanying drawings, which are incorporated herein and constitute part of this specification, illustrate example embodiments of the claims, and together with the general description given above and the detailed description given below, serve to explain the features of the claims.

FIG. 1A is a block diagram of an embodiment unsealed battery.

FIG. 1B is a block diagram of an embodiment unsealed battery showing the air electrode submerged.

FIG. 2 is a diagram of a portion of an embodiment bifunctional air electrode.

FIG. 3 is a diagram of a portion of an embodiment bifunctional air electrode.

FIGS. 4A and 4B are block diagrams of embodiment unsealed batteries.

FIG. 5A is a block diagram of an embodiment battery.

FIGS. 5B and 5C are schematics of the air inflated bifunctional air electrode during discharge (FIG. 5B) and charge (FIG. 5C).

FIGS. 6-14 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Reversible air electrodes for application in long duration energy storage systems (LODES) will need to be much more inexpensive than air electrodes for high power electrochemical devices (e.g., fuel cells, electrolyzers, etc.). For LODES, much lower current densities (<100 mA/cm²) are required at the air electrode, as compared to air electrodes for fuel cells or electrolyzers wherein greater current densities (>1 A/cm²) are required. As such, the electrode design space for LODES encompasses a variety of lower cost and/or lower purity materials that may offer lower, but tolerable, performance levels for LODES applications.

Various embodiments may provide low cost bifunctional air electrodes. Various embodiments may provide a unitary bifunctional air electrode including a metal substrate decorated with metal oxide and/or metal nitride catalysts to engage in the oxygen evolution reaction (OER) and/or the oxygen reduction reaction (ORR). Various embodiments may provide a unitary bifunctional air electrode including a metal substrate decorated with metal and metal oxide and/or metal nitride catalysts to engage in the oxygen evolution reaction (OER) and/or the oxygen reduction reaction (ORR). In various embodiments, the metal substrate may be any form of metal substrate. For example, the metal substrate may be a foil substrate, a sheet substrate, a mesh substrate, a foam substrate, a porous sintered solid substrate, etc. In various embodiments, the metal substrate may be formed from any metal. For example, the metal substrate may include one or more of iron, nickel, stainless steel, an iron alloy, such as nickel rich iron alloy (e.g., Inconel, Kovar®, etc.). As specific examples, the metal substrate may be steel wool or iron wool. Iron wool may be used when chromium leaching may be an issue due to toxicity or catalyst poisoning. Chromium leaching may occur when a Cr-containing alloy is exposed to OER conditions, as the Cr may be oxidized to form soluble Crⁿ⁺ cationic species. In certain embodiments, the propensity for chromium leaching is minimized by using a Cr-free or low-Cr-content metal or metal alloy. In various embodiments, particles of metal and/or particles of metal oxide and/or metal nitride catalyst may be coated onto the metal substrate to form the bifunctional air electrode. The metal catalyst coated onto the metal substrate may include any one or more of iron particles, or iron film, or nickel particles, or nickel film, or silver particles, or silver film, etc.

In some embodiments, the metal and/or metal oxide and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

The metal oxide catalyst may include or comprise any metal oxide catalyst, such as manganese oxide (MnO₂, Mn₂O₃, Mn₃O₄, MnₓO_{y}(where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc., other transition metal oxides or nitrides (such as Fe3N, FeCN, ZrN, Mn4N, or combinations thereof), or any combinations thereof. The particles of catalyst may be coated by electrodeposition, electroless plating, or other chemical deposition process. As an example, MnO₂ particles may be deposited via decomposition of permanganate (MnO₄⁻) to precipitate MnO₂ at the surface of the metal substrate. For example, the deposition of MnO₂ may occur through the permanganate decomposition reaction in alkaline media: 3MnO₄²⁻+2H²O→2MnO₄⁻+MnO₂+4OH⁻.

In some embodiments, sulfur is introduced onto the surface of an OER electrode as a method to increase surface area and/or modify catalytic activity at the surface. The deposition of sulfur is achieved by placing the electrode into a bath of sulfur containing solution (i.e. thiourea, aqueous metal sulfates, aqueous metal sulfides), then heat treated to form a surface of crystalline or amorphous metal sulfide or bimetallic sulfide bridges. In some embodiments, surface sulfurization is achieved by annealing in a sulfur-containing gas such as hydrogen sulfide (H₂S).

In various embodiments of the OER, the substrate is formed using silica. An OER electrode substrate is first formed by creating a high-porosity low-weight framework using silica. This framework may be produced from annealed/sintered silica particles. A low-cost metal (such as iron, aluminum, or an alloy of the two) is deposited onto the pre-formed framework. In a possible additional step, a catalytic species is added. This catalyst may include iron, nickel, tungsten, copper, zinc, or some alloy of the aforementioned metals. An optional next step is to treat the now formed electrode for mechanical integrity, surface area modification, or to form a surface species

Various embodiments may provide a bifunctional air electrode that may be a dual portion air electrode in which one portion of the air electrode material engages the ORR in a discharge mode and another portion of the air electrode material engages the OER in a charging (or re-charging) mode. In various embodiments, separate leads may be coupled to each portion of the bifunctional air electrode (e.g., a discharge lead coupled to the portion of the air electrode material that engages the ORR and a charge lead coupled to the portion of the air electrode material that engages the OER in a charging (or re-charging) mode) and the separate leads may be coupled to a switch configured to selectively electrically connect either of the leads (e.g., either the discharge lead or the charge lead) to an electrical lead coupled to a load or bus. The switch may toggle such that the appropriate lead connected to the appropriate portion of the air electrode is selected during battery charging and discharging. For example, the switch may electrically connect the discharge lead to the electrical lead and thereby the portion of the air electrode material that engages the ORR during discharge operations and the switch may electrically connect the charge lead to the electrical lead and thereby the portion of the air electrode material that engages the OER during charge operations. In various embodiments, the portion of the air electrode material that engages the ORR may include an ORR electrode and an ORR catalyst and the portion of the air electrode material that engage the OER may include an OER electrode and an OER catalyst. In various embodiments, the ORR electrode may include carbon cloth, carbon felt, carbon paper, or a gas diffusion layer (GDL).

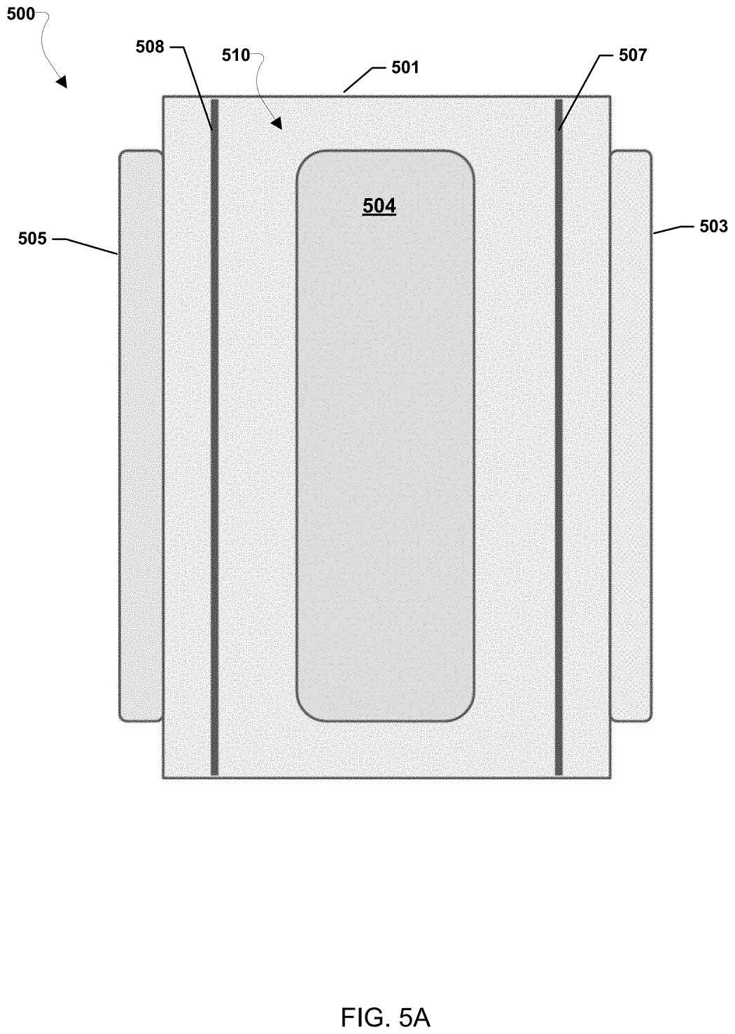

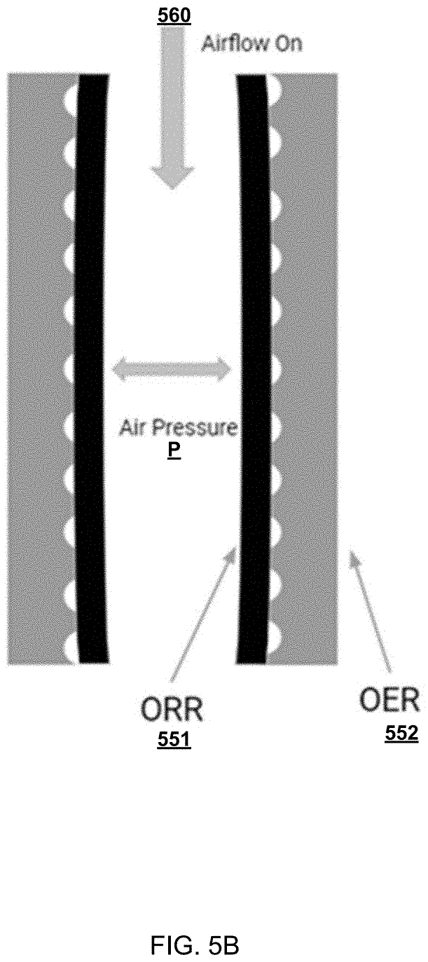

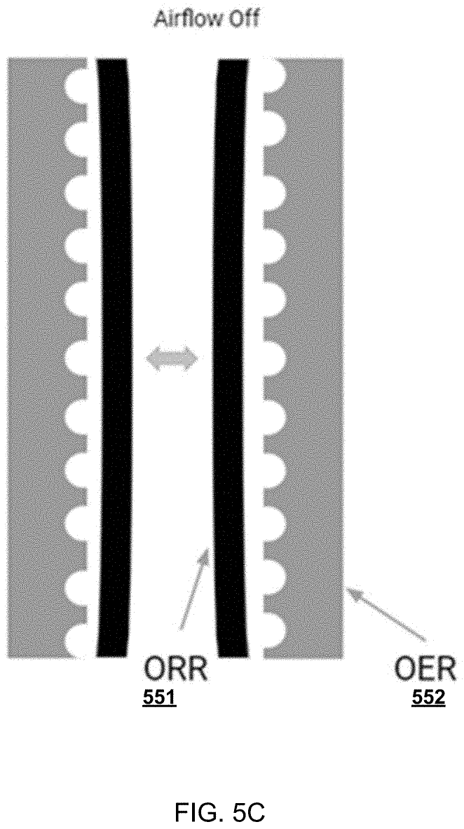

In some embodiments, the “dual portion” bifunctional air electrode relies on a rigid OER cathode and a flexible ORR cathode where the flexible ORR cathode is placed within a rigid metallic OER cathode, for example as illustrated in FIGS. 5B and 5C where the rigid OER cathode 552 is shown incasing the flexible ORR cathode 551. The ORR cathode 551 forms its own air pocket with air fed inside it. During discharge when air flow 560 is on, for example as illustrated in FIG. 5B, air pressure “P” pushes the electrode expanding the ORR cathode 551 against the OER cathode 552, connecting the ORR electrode 551 electronically to the load. During charge when air flow is off, for example as illustrated in FIG. 5C, the pressure “P” of the air flow is not present and the hydrodynamic forces of the electrolyte push the ORR cathode 551 off of the OER cathode 552, disconnecting ORR electrode electronically from the load.

In various embodiments, the ORR catalyst may include, silver, palladium, platinum, manganese oxide (MnO₂, Mn₂O₃, Mn₃O₄, MnₓO_{y}(where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (La₈Ca_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc. In certain embodiments the metal oxide catalysts may be mixed metal oxide catalysts, such as nickel iron oxide (Ni_{z}Fe_{1-z}O₈), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc.

Various embodiments may provide a method for making an air electrode including coating a metal substrate with particles of metal and/or metal oxide catalyst. In various embodiments, coating the metal substrate with the particles of metal and/or metal oxide catalyst may include electrodepositing, electroplating or electroless plating of the particles of metal and/or metal oxide catalyst onto the metal substrate in an acid solution. In various embodiments, a metal oxide layer, such as manganese oxide, may first be deposited, and then a second metal layer, such as nickel, may be subsequently deposited. In various embodiments, it may be preferable to first deposit a metal layer, such as nickel, on top of which a metal oxide layer, such as manganese oxide, may be subsequently deposited. This order of deposition may have several advantages. First, the deposition of the metallic layer may be smooth and dense, ensuring that the underlying substrate is fully covered and will not contact the electrolyte while in use. This is significant because the substrate may be selected purely on the basis of cost and conductivity, rather than solving for the additional constraints of chemical and electrochemical stability. The coating may be applied in various thicknesses, with thicker coatings being selected to provide greater protection to the underlying substrate, while thinner coatings may be selected to minimize cost of the coating. The second advantage may be that the metal coating is still conductive, so the metal oxide may be subsequently electrodeposited. In various embodiments, the surface area of the metal layer may be modified using process methods such as etching, oxidation and reduction, mechanical roughening, electroless plating, electrodeposition, electrochemical sintering, thermal sintering, intentional dendritic formation via electrodeposition, or any combination thereof. In various embodiments, the deposition of metal oxide may be tuned so that it only partially covers the metal layer, and thus the electrolyte may simultaneously contact both the metal and metal oxides.

In some embodiments, the metal and/or metal oxide catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

In various embodiments, bifunctional air electrodes may be coated with a hydrophobic coating, such as polyethylene (PE), polypropylene (PP), polyvinylidene fluoride (PVDF), polytetrafluoroethylene (PTFE), etc., or combinations thereof, either as physical mixtures or copolymers.

Various embodiments may provide a unitary, low-cost bifunctional electrode incorporating a metal substrate, decorated with metal and metal oxide catalysts to engage the OER, ORR, or both. In various embodiments, the metal substrate could be a metal mesh, foam, porous sintered solid. In some embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In some embodiments, binder materials such as polyethylene (PE), polypropylene (PP), polyvinylidene fluoride (PVDF), polytetrafluoroethylene (PTFE), or combinations thereof, may be included in the metal powder based porous substrates. Various embodiments may include different material combinations, such as: an iron substrate decorated with nickel particles and MnO₂ particles; a nickel substrate decorated with iron particles and MnO₂ particles; a nickel rich iron alloy (e.g., Invar, Kovar®, etc.) substrate decorated with MnO₂ particles; and a stainless steel substrate decorated with Ni and/or Fe particles for OER and MnO₂ particles for ORR. In other embodiments, particles of any of the above metal oxide catalysts may be included in addition to, or in place of, the MnO₂ particles. In various embodiments, the ORR catalyst may include silver, palladium, platinum, manganese oxide (MnO₂, Mn₂O₃, Mn₃O₄, MnₓO_{y}(where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}Mn_{y}O₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc. In certain embodiments the metal oxide catalysts may be mixed metal oxide catalysts, such as nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc.

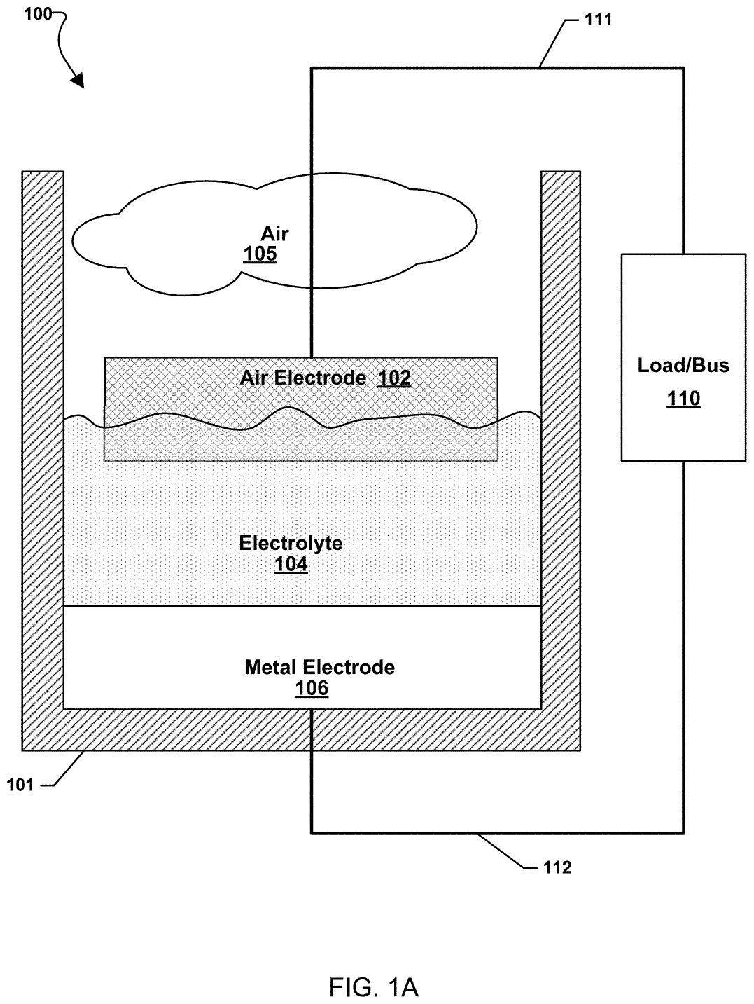

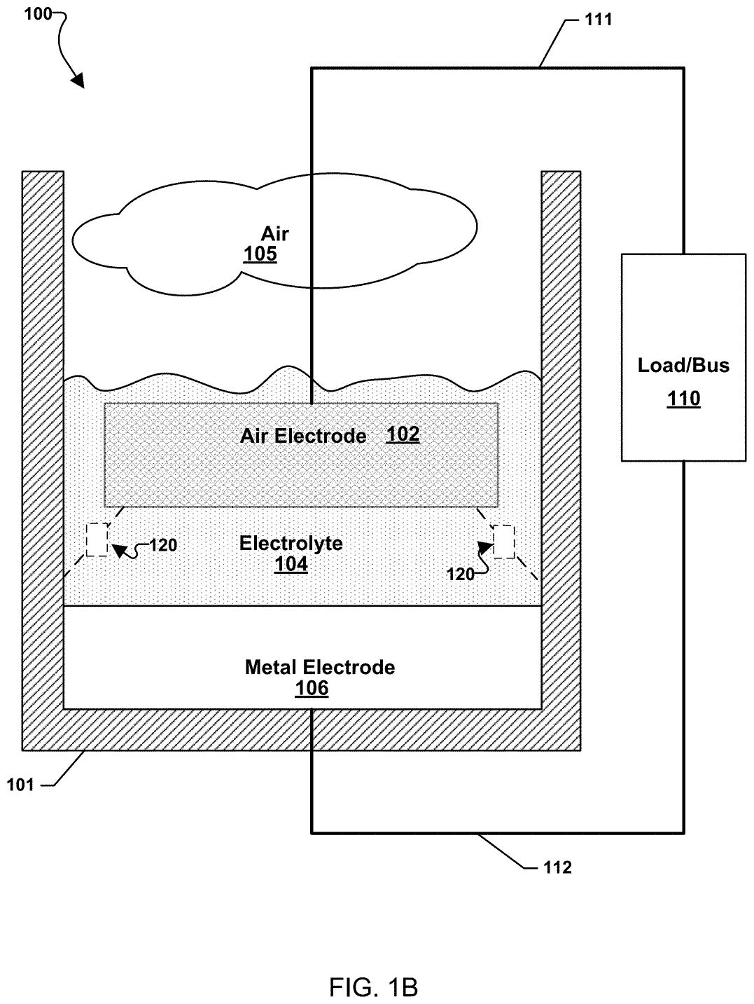

FIG. 1A is a block diagram of an embodiment unsealed battery 100 having a bifunctional air electrode 102, volume of liquid electrolyte 104, and metal electrode 106 disposed in a vessel 101. The vessel 101 may be open to the air 105, i.e., an air environment, and the bifunctional air electrode 102 may receive oxygen from the air 105. The bifunctional air electrode 102 may be configured to support OERs and/or ORRs in different modes of operation. The bifunctional air electrode 102 may be an air electrode that operates in both OER and ORR mode.

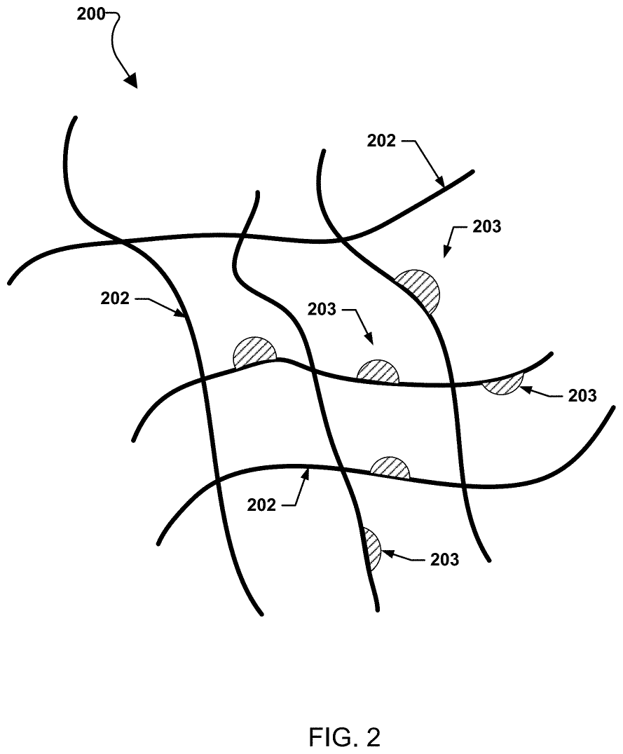

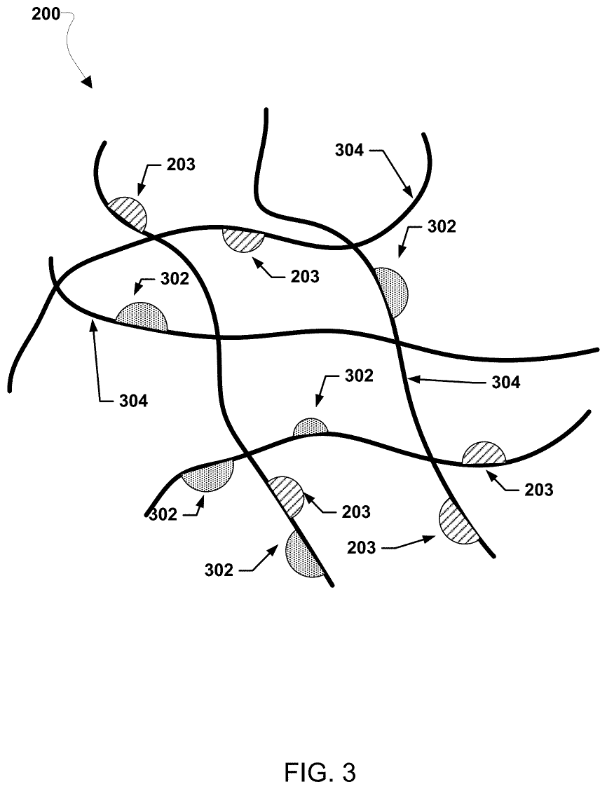

The bifunctional air electrode 102 may include a metal substrate having metal and/or metal oxide particles coated on the metal substrate. For example, the bifunctional air electrode 102 may be a bifunctional air electrode as described below with reference to FIGS. 2 and 3. The metal substrate may be configured in various forms, such as a foam, a mesh, a porous sintered solid, a cage, etc. The metal substrate may be formed from iron, nickel, iron-alloy, nickel rich iron-alloy, stainless steel, etc. The metal oxide particles may be particles of silver, palladium, platinum, manganese oxide (MnO₂, Mn₂O₃, Mn₃O₄, MnₓO_{y}(where x=1 to 3 and y=1 to 8)), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}(where x=0 to 2 and y=0 to 3)), cobalt oxide (Co₃O₄, CoₓO_{y}(where x=1 to 3 and y=1 to 8)), manganese cobalt oxide (MnCo₂O₄, Mn₁₊ₓCo₂₋ₓO₄ (where x=0 to 2)), cobalt manganese oxide (CoMn₂O₄), nickel manganese oxide (NiMnOₓ (where x=2 to 4)), manganese iron oxide (MnFe₂O₄, Mn₁₊ₓFe₂₋ₓO₄ (where x=0 to 1)), nickel-doped manganese oxide (Ni—MnₓO_{y} (where x=1 to 3 and y=1 to 8)), manganese cobalt iron oxide (MnₓCo_{y}Fe_{z}O₄ (where x=0 to 4 and y=0 to 4 and z=0 to 4)), zinc cobalt manganese oxide (ZnCoMnO₄, ZnₓCo_{y}Mn_{z}O₄ (where x=0 to 4 and y=0 to 4 and z=0 to 4)), cobalt nickel oxide (CoNiOₓ (where x=0 to 4)), calcium manganese oxide (CaMnOₓ (where x=0 to 4)), lanthanum manganese oxide (LaMnO₃), lanthanum cobalt oxide (LaCo₂O₄, La₁₊ₓCo₂₋ₓO₄ (where x=0 to 2), lanthanum nickel oxide (LaNiO₃), lanthanum calcium aluminum manganese oxide (LaₓCa_{y}Al_{z}MnᵥO₃ (where x=0 to 3 and y=0 to 3 and z=0 to 2 and v=0 to 3)), nickel iron oxide (Ni_{z}Fe_{1-z}Oₓ (where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc.

The metal particles may be particles of iron or nickel. In various embodiments, the bifunctional air electrode 102 may be made by coating a metal substrate with particles of metal and/or metal oxide catalyst. In various embodiments, coating the metal substrate with the particles of metal and/or metal oxide catalyst may include electrodepositing, electroplating, or electroless plating of the particles of metal and/or metal oxide catalyst onto the metal substrate in an acid solution. In various embodiments, the surface area of the metal and/or metal oxide layer may be modified using process methods such as etching, oxidation and reduction, mechanical roughening, electrodeposition, electrochemical sintering, thermal sintering, intentional dendritic formation via electrodeposition, or any combination thereof. In some embodiments, the metal and/or metal oxide catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied. In various embodiments, the bifunctional air electrode 102 may be coated with a hydrophobic coating, such as polyethylene or polypropylene.

The metal electrode 106 may be formed from a metal or metal alloy, such as lithium (Li), sodium (Na), potassium (K), magnesium (Mg), calcium (Ca), silicon (Si), aluminum (Al), zinc (Zn), iron (Fe), sulfur (S); or alloys substantially comprised of one or more of the forgoing metallic elements, such as an aluminum alloy or iron alloy (e.g., FeAl, FeZn, FeMg, etc.). The metal electrode 106 may be a solid, including a dense or porous solid, or a mesh or foam, or a particle or collection of particles, or may be a slurry, ink, suspension, or paste deposited within the vessel 101. In various embodiments, the metal electrode 106 composition may be selected such that the metal electrode 106 and the volume of liquid electrolyte 104 may not mix together. For example, the metal electrode 106 may be a bulk solid. As another example, the metal electrode 106 may be a collection of particles, such as small or bulky particles, within a suspension that are not buoyant enough to escape the suspension into the electrolyte. As another example, the metal electrode 106 may be formed from particles that are not buoyant in the electrolyte.

In certain embodiments the metal electrode 106 may be formed from a sulfur-based material, such as an aqueous polysulfide solution or a dispersion of sulfur or sulfide in aqueous media, or a mixture of polysulfide solution and sulfur or sulfide solids. For example, the metal electrode materials may include, sulfur (S₈), lithium (poly)sulfides (Li₂Sₓ, where x=1 to 8), sodium (poly)sulfides (Na₂Sₓ, where x=1 to 8) and/or potassium (poly)sulfides (K₂Sₓ, where x=1 to 8). In some embodiments, the metal electrode materials may include a transition metal sulfide, such as TiSₓ, FeSₓ, and/or MnSₓ, [wherein x=1 or 2] may provide a high operating voltage and a corresponding energy density, and may also be highly resistive to polysulfide crossover. In some embodiments, polysulfide solutions may have a pH>10. For example, such solution may have an OH− concentration of about 0.1M or greater, and may have a polysulfide (e.g., Sₓ) concentration of about 1M or greater, such as from about 1M to about 10M.

The volume of liquid electrolyte 104 may be disposed between the bifunctional air electrode 102 and the metal electrode 106 such that the bifunctional air electrode 102 and the metal electrode 106 are electrically isolated while remaining in ionic contact via the volume of liquid electrolyte 104. In this manner the volume of liquid electrolyte 104 may act as an electrolyte layer separating the bifunctional air electrode 102 and the metal electrode 106. The volume of liquid electrolyte 104 may cover the metal electrode 106 such that the metal electrode 106 is submerged in the volume of liquid electrolyte 104. In this manner the volume of liquid electrolyte 104 may form a barrier between the metal electrode 106 and oxygen in the air 105. The composition of the volume of liquid electrolyte 104 may be selected such that the liquid electrolyte has a low solubility of oxygen, thereby preventing oxygen from the air 105 from reaching the metal electrode 106. The solubility of oxygen in the volume of liquid electrolyte 104 may be tailored to meet different oxygen barrier goals. The exposure of the metal electrode 106 to oxygen may be limited to prevent parasitic self-discharging of the metal electrode 106. The volume of liquid electrolyte 104 may serve as a barrier between the metal electrode 106 and gaseous oxygen from the air 105. In various embodiments, redox mediators, such as K₃Fe(CN)₆, Na₃Fe(CN)₆, or Na₄Fe(CN)₆ in small quantity (e.g., less than 0.1M) may be used as the redox mediator/shuttle for oxygen reduction reaction and/or oxygen evolution reaction in a strong alkaline electrolyte. Similarly, other redox active compounds with fast and reversible electron transfer capability may be used as the redox mediator/shuttle for ORR/OER in various embodiments.

The bifunctional air electrode 102 may be coupled to an electrical lead 111 coupled to a load or bus 110. The metal electrode 106 may be coupled to another electrical lead 112 connected to the load or bus 110. In a charging (or recharging) mode of operation the load or bus 110 may output electrical energy to the air electrode 102 via the electrical lead 111. In a discharging mode of operation the bifunctional air electrode 102 may output electrical energy to the load or bus 110 via the electrical lead 111.

In various embodiments, the bifunctional air electrode 102 may change position. For example, the bifunctional air electrode 102 may change position from a floating position located at the electrolyte 104 and air 105 interface as shown in FIG. 1A to a fully submerged position in the electrolyte 104 as shown in FIG. 1B. Changing position of the bifunctional air electrode 102 may enable the performance of both OER and ORR reactions to be maximized During ORR, the bifunctional air electrode 102 may be located at the electrolyte 104 and air 105 interface as shown in FIG. 1A where the triple-phase boundary may be maximized. During OER, the bifunctional air electrode 102 may be located fully submerged in the electrolyte 104 thereby maximizing the bifunctional air electrode 102 to electrolyte 104 interface. Additionally, submerging the bifunctional air electrode 102 may favor good mass transport by allowing bubbles to freely escape the bifunctional air electrode 102. The position of the bifunctional air electrode 102 may be varied by any manner. As one example, the bifunctional air electrode 102 may be connected to an optional actuated tensioning system 120 (e.g., a screw drive, tension-able cable, etc.) illustrated in FIG. 1B and the bifunctional air electrode 102 may be inherently buoyant in the electrolyte 104. The actuated tensioning system 120 may be released during ORR to enable the bifunctional air electrode 102 to float on the electrolyte 104 as shown in FIG. 1A. During OER, the actuated tensioning system 120 may be activated to pull the bifunctional air electrode 102 into the electrolyte 104 to submerge the bifunctional air electrode 102 as shown in FIG. 1B. As another example, the buoyancy of the electrolyte 104 may be changed between the ORR and OER such that during ORR the bifunctional air electrode 102 floats as shown in FIG. 1A and during OER the bifunctional air electrode 102 sinks to submerge in the electrolyte 104.

FIG. 2 illustrates a portion of an embodiment bifunctional air electrode 200. In various embodiments, bifunctional air electrode 200 may be used as the bifunctional air electrode 102 in the battery system 100 described above with reference to FIGS. 1A and 1B. The bifunctional air electrode 200 may include a metal alloy substrate 202. The metal alloy substrate 202 may be formed as a mesh, a foam, a porous sintered solid, a cage, etc. As one example, the metal alloy substrate 202 may be formed from a nickel rich iron alloy (e.g., Inconel, Kovar®, etc.). The metal alloy substrate 202 may be coated with particles of metal oxide catalyst 203. As one example, the particles of metal oxide catalyst 203 may be deposits of manganese oxide (MnO₂) As another example, the particles of metal oxide catalyst 203 may be deposits of nickel oxide (NiOₓ) As another example, the particles of metal oxide catalyst 203 may be deposits of nickel oxyhydroxide (NiOₓ(OH)_{y}). As another example, the particles of metal oxide catalyst 203 may be deposits of iron oxide (FeOₓ) As another example, the particles of metal oxide catalyst 203 may be deposits of iron oxyhydroxide (FeOₓ(OH)_{y}). As another example, the particles of metal oxide catalyst 203 may be deposits of mixed transition metal oxides such as manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc. In other embodiments, the particles of metal oxide catalyst 203 may include any of the metal oxide catalysts described above. In various embodiments, the ORR catalyst may include manganese oxide, silver, platinum, cobalt oxide (Co₃O₄), nickel iron oxide (Ni_{z}Fe_{1-z}Oₓ), manganese ferrite (MnFe₂O₄), zinc ferrite (ZnFe₂O₄), nickel cobaltite (NiCo₂O₄), or lanthanum strontium manganate (La_{0.8}Sr_{0.2}MnO₃), etc. In various embodiments, the OER catalyst may include manganese oxide, nickel, iron, nickel oxide (NiOₓ), nickel oxyhydroxide (NiOₓ(OH)_{y}), iron oxide (FeOₓ), or iron oxyhydroxide (FeOₓ(OH)_{y}), etc.

In various embodiments, the bifunctional air electrode 200 may be coated with a hydrophobic coating, such as polyethylene (PE), polypropylene (PP), polyvinylidene fluoride (PVDF), polytetrafluoroethylene (PTFE), etc., or combinations thereof, either as physical mixtures or copolymers.

FIG. 3 is a diagram of a portion of an embodiment bifunctional air electrode. In various embodiments, bifunctional air electrode 300 may be used as the bifunctional air electrode 102 in the battery system 100 described above with reference to FIGS. 1A and 1B. The bifunctional air electrode 200 may include a metal substrate 304. The metal substrate 304 may be formed as a mesh, a foam, a porous sintered solid, a cage, etc. As examples, the metal substrate 304 may be formed from a nickel rich iron alloy (e.g., Inconel, Kovar®, etc.), iron, nickel, iron-alloy, stainless steel, etc. The metal substrate 304 may be coated with particles of metal oxide catalyst 203. As one example, the particles of metal oxide catalyst 203 may be deposits of manganese oxide (MnO₂, Mn₂O₃, Mn₃O₄, MnₓO_{y} such as where x=1 to 3 and y=1 to 8). As another example, the particles of metal oxide catalyst 203 may be deposits of mixed transition metal oxides such as (Ni_{z}Fe_{1-z}Oₓ), ZnₓCo_{y}Mn_{z}O₄). As another example, the particles of metal oxide catalyst 203 may be deposits of cobalt nickel oxide (CONiOₓ) As another example, the particles of metal oxide catalyst 203 may be deposits of calcium manganese oxide (CaMnOₓ). As another example, the particles of metal oxide catalyst 203 may be deposits of lanthanum manganese oxide (LaMnO₃). As another example, the particles of metal oxide catalyst 203 may be deposits of lanthanum cobalt oxide (LaCo₂O₄, La₁₊ₓCo₂₋ₓO₄) As another example, the particles of metal oxide catalyst 203 may be deposits of lanthanum nickel oxide (LaNiO₃). As another example, the particles of metal oxide catalyst 203 may be deposits of lanthanum calcium aluminum manganese oxide (LaₓCa_{y}Al_{z}Mn_{y}O₃). As another example, the particles of metal oxide catalyst 203 may be deposits of nickel iron oxide (Ni_{z}Fe_{1-z}Oₓ). As another example, the particles of metal oxide catalyst 203 may be deposits of manganese ferrite (MnFe₂O₄). As another example, the particles of metal oxide catalyst 203 may be deposits of zinc ferrite (ZnFe₂O₄). As another example, the particles of metal oxide catalyst 203 may be deposits of nickel cobaltite (NiCo₂O₄). As another example, the particles of metal oxide catalyst 203 may be deposits of lanthanum strontium manganate (La_{0.8}Sr_{0.2}MnO₃), etc. The metal substrate 304 may be coated with particles of metal 302. As examples, the particles of metal 302 may be deposits of iron, nickel, etc.

As specific examples: the metal substrate 304 may be formed of iron, the particles of metal 302 may be deposits of nickel, and the particles of metal oxide catalyst 203 may be deposits of manganese oxide; the metal substrate 304 may be formed of nickel, the particles of metal 302 may be deposits of iron, and the particles of metal oxide catalyst 203 may be deposits of manganese oxide; the metal substrate 304 may be formed of stainless steel, the particles of metal 302 may be deposits of nickel, and the particles of metal oxide catalyst 203 may be deposits of manganese oxide; or the metal substrate 304 may be formed of stainless steel, the particles of metal 302 may be deposits of iron, and the particles of metal oxide catalyst 203 may be deposits of manganese oxide. In various embodiments, the bifunctional air electrode 300 may be coated with a hydrophobic coating, such as polyethylene (PE), polypropylene (PP), polyvinylidene fluoride (PVDF), polytetrafluoroethylene (PTFE), etc., or combinations thereof, either as physical mixtures or copolymers.

Bifunctional air electrodes tend to have durability issues that may be caused by internal electrode resistance due to inadequate electrode fabrication methods. To address such issues, in various embodiments, the bifunctional air electrode may be a three layer single electrode including the following components: a gas diffusion layer; oxygen reduction catalyst (e.g., transition metal oxides, precious metals, or perovskites); oxygen evolution catalyst (transition metals, transition metal oxides or lanthanide series oxides); conductive catalyst substrates; and a current collector oriented in a prismatic fashion.

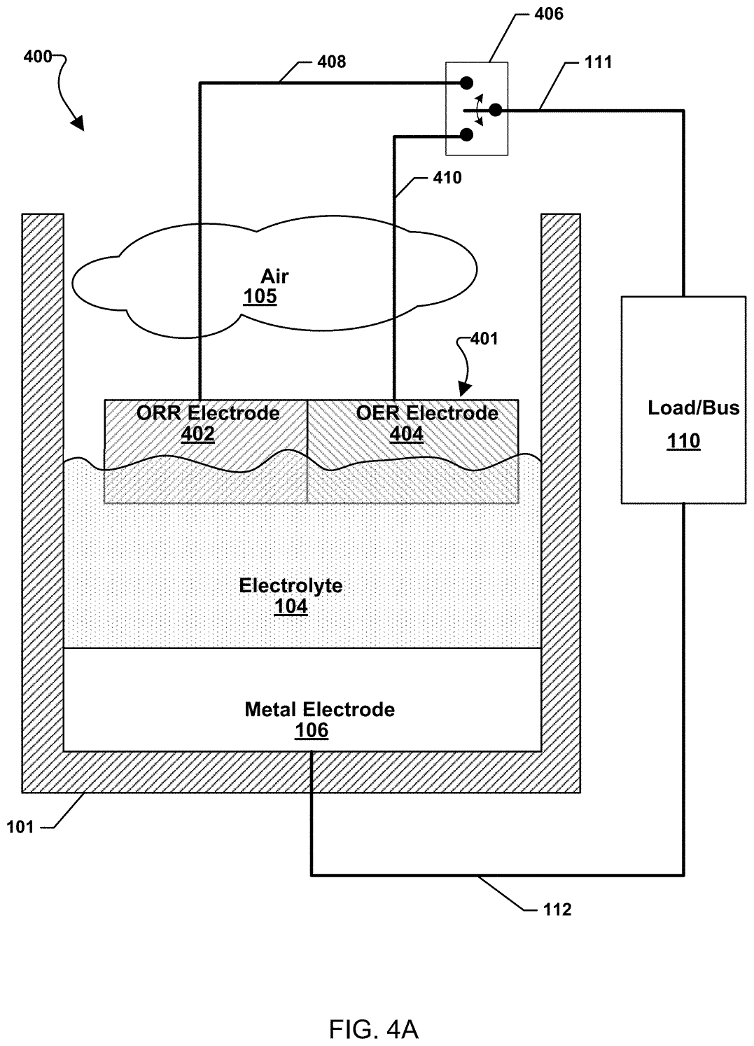

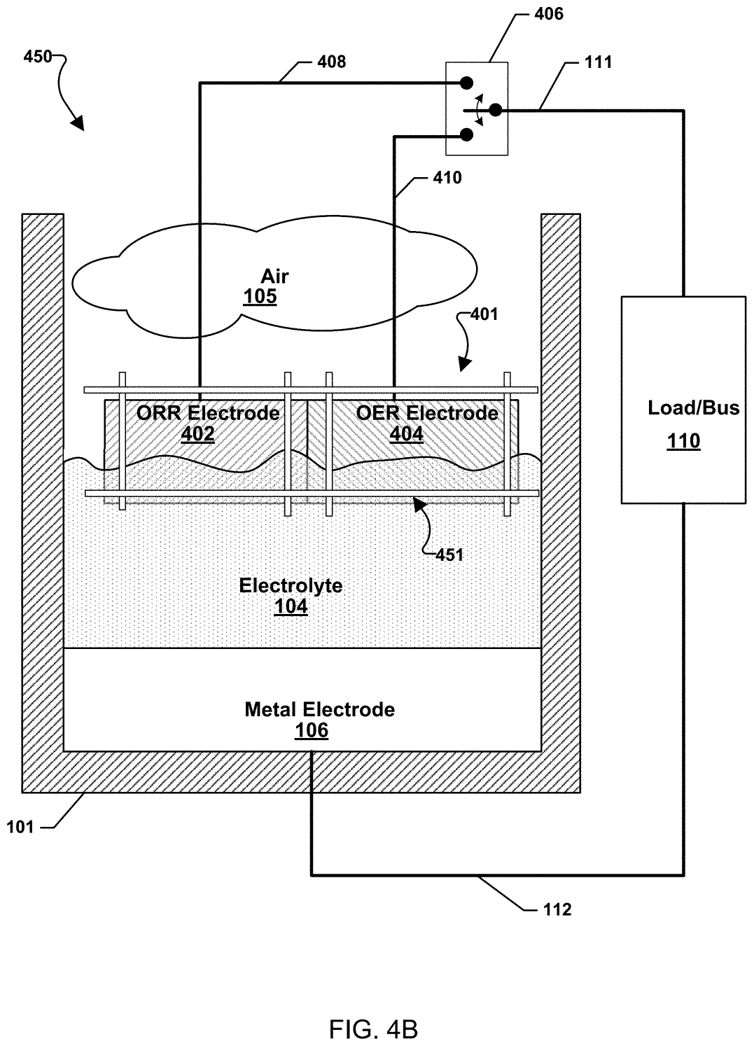

FIG. 4A is a block diagram of an embodiment unsealed battery 400. Battery 400 is similar to battery 100 described above with reference to FIGS. 1A and 1B, except that the bifunctional air electrode 102 is replaced with a bifunctional air electrode 401 that is a dual portion air electrode having a first portion 402 and a second portion 404. The first portion 402 may be configured to engage an ORR in a discharge mode and the second portion 404 may be configured to engage an OER in a charge (or recharge) mode. The first portion 402 may include an ORR electrode and an ORR catalyst and the second portion 404 may include an OER electrode and an OER catalyst. As examples, the ORR electrode may be formed from carbon cloth, carbon felt, carbon paper, a GDL, etc. As examples, the ORR catalyst may be formed from manganese oxide, platinum, silver, etc. As examples, the OER electrode may be formed from nickel, iron, stainless steel, carbon steel, titanium, etc. As examples, the OER catalyst may be formed from manganese oxide, nickel, iron, etc. In other embodiments, the ORR and OER catalyst may include any of the above described metal or metal oxide catalysts.

In various embodiments, the ORR catalyst may include silver, palladium, platinum, manganese oxide (MnO₂, Mn₂O₃, Mn₃O₄, MnₓO_{y} such as where x=1 to 3 and y=1 to 8), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y} such as where x=0 to 2 and y=0 to 3), cobalt oxide (Co₃O₄, CoₓO_{y} such as where x=1 to 3 and y=1 to 8), manganese cobalt oxide (MnCo₂O₄, Mn₁₊ₓCo₂₋ₓO₄ such as where x=0 to 2), cobalt manganese oxide (CoMn₂O₄), nickel manganese oxide (NiMnOₓ such as where x=2 to 4), manganese iron oxide (MnFe₂O₄, Mn₁₊ₓFe₂₋ₓO₄ such as where x=0 to 1), nickel-doped manganese oxide (Ni—MnₓO_{y} such as where x=1 to 3 and y=1 to 8), manganese cobalt iron oxide (MnₓCo_{y}Fe_{z}O₄ such as where x=0 to 4 and y=0 to 4 and z=0 to 4), zinc cobalt manganese oxide (ZnCoMnO₄, ZnₓCo_{y}Mn_{z}O₄ such as where x=0 to 4 and y=0 to 4 and z=0 to 4)), cobalt nickel oxide (CoNiOₓ such as where x=0 to 4)), calcium manganese oxide (CaMnOₓ such as where x=0 to 4)), lanthanum manganese oxide (LaMnO₃), lanthanum cobalt oxide (LaCo₂O₄, La₁₊ₓCo₂₋ₓO₄ such as where x=0 to 2), lanthanum nickel oxide (LaNiO₃), lanthanum calcium aluminum manganese oxide (LaₓCa_{y}Al_{z}MnO₃ such as where x=0 to 3 and y=0 to 3 and z=0 to 2 and v=0 to 3)), etc. In certain embodiments the metal oxide catalysts may be mixed metal oxide catalysts, such as nickel iron oxide (Ni_{z}Fe_{1-z}Oₓ such as where z=0 to 1 and x=0.5 to 2.5), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), etc. In various embodiments, the ORR electrode and/or OER electrode may be a mesh, a foam, a porous sintered solid, etc. In various embodiments, the bifunctional air electrode 401 may be coated with a hydrophobic coating, such as polyethylene (PE), polypropylene (PP), polyvinylidene fluoride (PVDF), polytetrafluoroethylene (PTFE), etc., or combinations thereof, either as physical mixtures or copolymers. For example, the first portion 402 and/or the second portion 404 may be coated with a hydrophobic coating, such as polyethylene (PE), polypropylene (PP), polyvinylidene fluoride (PVDF), polytetrafluoroethylene (PTFE), etc., or combinations thereof, either as physical mixtures or copolymers. In various embodiments, to enhance the surface area of the conductive substrate forming the first portion 402 and/or the second portion 404, micro (1-100 um) and mesoscale (100 nm-1 um) conductive particles may be deposited onto the substrate. Then electrodeposition or electroless plating with a more corrosion/oxidation resistant metal, such as nickel, may be performed on the substrate. This plating with a more corrosion/oxidation resistant metal may both protect the underlying substrate and the micro (1-100 um) and mesoscale (100 nm-1 um) conductive particles from corrosion and trap/confine particles to the surface and therefore improve adhesion and overall conductivity. If the protective more corrosion/oxidation resistant metal layer is not catalytically active, then after the plating, meso (100 nm-1 um) and nanoscale (1-100 nm) catalysts, such as cobalt or manganese, may be deposited onto the substrate.

Each portion 402, 404 of the bifunctional air electrode 401 may be coupled to its own respective lead 408, 410 that are coupled to a switch 406. For example, a discharge lead 408 may couple the first portion 402 configured to engage an ORR in a discharge mode to the switch 406 and a charge lead 410 may couple the second portion 404 configured to engage an OER in a charge (or recharge) mode to the switch 406. The switch 406 may be coupled to the electric lead 111 coupled to the load or bus 110. The switch 406 may be configured to selectively electrically connect either the discharge lead 408 or the charge lead 410 to the electrical lead 111 thereby electrically connecting either the first portion 402 of the bifunctional air electrode 401 to the load or bus 110 or the second portion 404 of the bifunctional air electrode 401 to the load or bus 110. For example, in a charging (or recharging) mode of operation the load or bus 110 may output electrical energy to the second portion of the bifunctional air electrode 401 via the electrical lead 111 and charge lead 410 connected by the switch 406. In a discharging mode of operation the first portion 402 of the bifunctional air electrode 401 may output electrical energy to the load or bus 110 via the discharge lead 408 electrically connected to the electrical lead 111 by the switch 406. In various embodiments, the switch 406 may be a semiconductor switch operated both to provide for disconnecting/connecting the ORR electrode 402 and/or OER electrode 404, as well as to operate as the switching mechanism for a DC/DC power converter. The DC/DC power converter may be used to control the potential of the ORR electrode 402 in a range where the ORR electrode 402 may be used to recombine hydrogen evolved at the metal electrode 106.

FIG. 4B is a block diagram of an embodiment unsealed battery 450. Battery 450 is similar to battery 400 described above with reference to FIG. 4A, except that the bifunctional air electrode 401 that is a dual portion air electrode having a first portion 402 and a second portion 404 is illustrated in FIG. 4B including a metal substrate in the form of a cage (of which a portion 451 of the cage is shown in FIG. 4B) configured to operate as a current collector and having openings configured for electrolyte 104 and air flow 105. The cage may comprise any of the materials discussed herein from which a metal substrate may be formed. As specific examples, the cage may comprise iron, nickel, and/or a nickel-iron alloy. In various embodiments, the cage may be coated with a catalyst. As examples, the catalyst may include silver, palladium, platinum, manganese oxide (MnO₂, Mn₂O₃, Mn₃O₄, MnₓO_{y} such as where x=1 to 3 and y=1 to 8), nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y} such as where x=0 to 2 and y=0 to 3), cobalt oxide (Co₃O₄, CoₓO_{y} such as where x=1 to 3 and y=1 to 8), manganese cobalt oxide (MnCo₂O₄, Mn₁₊ₓCo₂₋ₓO₄ such as where x=0 to 2), cobalt manganese oxide (CoMn₂O₄), nickel manganese oxide (NiMnOₓ such as where x=2 to 4), manganese iron oxide (MnFe₂O₄, Mn₁₊ₓFe₂₋ₓO₄ such as where x=0 to 1), nickel-doped manganese oxide (Ni—MnₓO_{y} such as where x=1 to 3 and y=1 to 8), manganese cobalt iron oxide (MnₓCo_{y}Fe_{z}O₄ such as where x=0 to 4 and y=0 to 4 and z=0 to 4), zinc cobalt manganese oxide (ZnCoMnO₄, ZnₓCo_{y}Mn_{z}O₄ such as where x=0 to 4 and y=0 to 4 and z=0 to 4)), cobalt nickel oxide (CoNiOₓ such as where x=0 to 4)), calcium manganese oxide (CaMnOₓ such as where x=0 to 4)), lanthanum manganese oxide (LaMnO₃), lanthanum cobalt oxide (LaCo₂O₄, La₁₊ₓCo₂₋ₓO₄ such as where x=0 to 2), lanthanum nickel oxide (LaNiO₃), lanthanum calcium aluminum manganese oxide (LaₓCa_{y}Al_{z}MnᵥO₃ such as where x=0 to 3 and y=0 to 3 and z=0 to 2 and v=0 to 3)), nickel iron oxide (Ni_{z}Fe_{1-z}Oₓ such as where z=0 to 1 and x=0.5 to 2.5)), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, metallic nickel, metallic iron, one or more metal nitrides, Fe₃N, FeCN, ZrN, Mn₄N, or any combinations thereof.

FIG. 5 is a block diagram of an embodiment battery 500. The battery 500 may include a volume of liquid electrolyte 510, an ORR air electrode 505 that may be air breathing, and a metal electrode 504, disposed in a vessel 501, and an OER electrode 503. The ORR air electrode 505 may receive oxygen from the air. The battery may be configured to support OERs and/or ORRs in different modes of operation (e.g., charge (or recharge), discharge) through its ORR air electrode 505 and OER electrode 503. A first separator 508 may be disposed in the vessel 501 between the ORR air electrode 505 and the metal electrode 504. A second separator 507 may be disposed in the vessel 501 between the OER electrode 503 and the metal electrode 504. In some embodiments, the OER electrode 503 may be immersed in the electrolyte 510. In some embodiments, an electrolyte 510 circulating system may be included in the battery 500.

The metal electrode 504 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.). The metal electrode 504 may be a solid, including a dense or porous solid, or a mesh or foam, or a particle or collection of particles, or may be a slurry, ink, suspension, or paste deposited within the vessel 501. In various embodiments, the metal electrode 504 composition may be selected such that the metal electrode 504 and the volume of liquid electrolyte 510 may not mix together. For example, the metal electrode 504 may be a bulk solid. In some embodiments, the metal electrode may include sulfur and polysulfide species, as described above, including aqueous species. In certain embodiments the metal electrode 504 may be formed from a sulfur-based material, such as an aqueous polysulfide solution or a dispersion of sulfur or sulfide in aqueous media, or a mixture of polysulfide solution and sulfur or sulfide solids. For example, the metal electrode materials may include, sulfur (S₈), lithium (poly)sulfides (Li₂S₈, where x=1 to 8), sodium (poly)sulfides (Na₂Sₓ, where x=1 to 8) and/or potassium (poly)sulfides (K₂Sₓ, where x=1 to 8). In some embodiments, the metal electrode materials may include a transition metal sulfide, such as TiSₓ, FeSₓ, and/or MnSₓ, [wherein x=1 or 2] may provide a high operating voltage and a corresponding energy density, and may also be highly resistive to polysulfide crossover. In some embodiments, polysulfide solutions may have a pH>10. For example, such solution may have an OH-concentration of about 0.1M or greater, and may have a polysulfide (e.g., Sₓ) concentration of about 1M or greater, such as from about 1M to about 10M.

The volume of liquid electrolyte 510 may be disposed between the ORR air electrode 505, the OER electrode 503, and the metal electrode 504 such that the ORR air electrode 505 and metal electrode 504, as well as the OER electrode 503 and the metal electrode 504, are electrically isolated while remaining in ionic contact via the volume of liquid electrolyte 510. In this manner the volume of liquid electrolyte 510 may act as an electrolyte layer separating the ORR air electrode 505 and the metal electrode 504 and separating the OER electrode 503 and the metal electrode 504.

Each of the OER electrode 503 and the ORR air electrode 505 may be coupled to its own respective lead. These respective leads may be selectively connected to buses and/or loads depending on the mode of operation (e.g., charging (or recharging) or discharging). For example, in a discharging mode the ORR air electrode 505 may be electrically connected to the bus or load and in a charging (or recharging) mode the OER electrode 503 may be electrically connected to the bus or load. In this manner, different ones of the electrodes 503, 505 may be used in different modes of operation.

For dual air electrode batteries, such as the battery 500 illustrated in FIG. 5, the ORR air electrode 505 and OER electrode 503 do not have to be co-located/adjacent or electrically connected. In various embodiments, the ORR air electrode 505 and OER electrode 503 may be separated by an on/off switch to avoid OER potentials at the ORR air electrode. In various embodiments, the ORR air electrode 505 and OER electrode 503 may be positioned separately to optimize their respective reactions. For example, the OER electrode 503 may be immersed to maximize the amount of available reactant (e.g. H₂O and OH⁻). Similarly, the ORR air electrode 505 may be positioned at the gas/liquid interface to maximize the amount of gaseous oxygen and dissolved oxygen reactants. The material and form of one or both of the ORR air electrode 505 and OER electrode 503 may be independently selected for either OER or ORR.

In various embodiments, the sizes of ORR air electrode 505 and the OER electrode 503 may not be equal and may be tailored independently to select for various goals, such as performance versus cost goals of the battery 500. Bubble management may generally be a challenge for metal/air architectures, such as iron/air cell architectures. Additionally, oxygen bubbles produced at a submerged OER electrode 503 may transport to a charged metal electrode 504 (e.g., an iron anode), invoking self-discharge and/or low coulombic efficiency during charging. By over-sizing the OER electrode 503 relative to the metal electrode 504 (e.g., the iron anode), the effective geometric current density on the OER electrode 503 may be much smaller than the geometric current density on the metal electrode 504 (e.g., iron anode). The low OER current density may preferentially lead to smaller and more delocalized bubble formation. This may make bubbling rate inside the cell less aggressive, helping to improve bubble management issues.

In various embodiments, high surface area iron-rich materials such as porous direct reduced iron (DRI) pellets, sponge iron, or atomized iron powder, may be used as a low-cost high surface area conductive iron substrate for an OER electrode, such as OER electrode 404, OER electrode 503, etc. For example, when DRI pellets are used, the DRI pellets may be used as-received, broken into smaller pieces or powder, an/or further processed to further modify (typically increase) surface area, e.g. by etching or oxidation, hydrothermal treatments, mechanical roughening, electrodeposition, electroless plating, electrochemical sintering, thermal sintering, or any combination thereof. Transition metal and/or other OER catalysts may then be deposited onto the DRI pellets (whether used as-received, broken down, and/or further processed). These catalysts (such as nickel, cobalt, or manganese oxides) may be deposited via electrodeposition, electroless plating, thermal precipitation, galvanic replacement reaction, or other decomposition methods. In some embodiments, the metal and/or metal oxide catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

For all electrodes, surface area is directly proportional to current generated. Therefore it is advantageous for an electrode to have a large surface area per unit cost of electrode. In most cases it is also advantageous to have a large surface area per unit volume of the electrode. The maximum surface area attainable per unit volume could be accomplished by designing an electrode with a fractal structure. In various embodiments, the creation of an electrode with a fractal structure may be accomplished by modification of inexpensive conductive electrode substrates like carbon steel mesh or steel wool. The first surface roughening step may be to introduce microscopic (1 um-100 um) features to the electrode substrate either by the addition of similarly conductive material (such as through oxidation, sintering of particles, precipitation or decomposition of salts, electroless plating, electrodeposition, or intentional dendritic formation via electrodeposition, etc.), or by removal of material from the substrate (such as by mechanical roughening, sandblasting, acid etching, laser etching, etc.), or a combination of material addition and removal. This leads to an increase in specific surface area (m²/g)—as may be measured by a gas adsorption measurement such as BrunauerEmmettTeller (BET) adsorption technique—without increasing the overall mass (g) or overall volume (mL) of the electrode material significantly. A next step may be to introduce mesoscopic (100 nm-1 um) features to the electrode through similar process steps (e.g., material addition and/or removal). The final step may be to introduce nanoscale (1 nm-100 nm) features with similar process steps (e.g., material addition and/or removal), or with the deposition of catalyst nanoparticles. If the process steps are combined in this order (from microscopic to mesoscopic to nanoscopic), then the surface area enhancement benefit of each step may be multiplicative, meaning if a 10× increase is achieved with the first process step introducing microscopic features, and a 10× increase in surface area is achieved by the second process step introducing mesoscopic features, and a third process step introduces nanoscopic features which provide another 10× surface area increase, then the overall gain in surface area may be 1000× (i.e., 10×10×10).

Various embodiments may provide a method for making an air electrode, the method comprising coating a metal substrate with particles of metal oxide catalyst. The method may include coating the metal substrate with the particles of metal oxide catalyst comprises electrodepositing or electroplating the particles of metal oxide catalyst onto the metal substrate in an acid solution. The method may include depositing a metallic layer on the substrate prior to coating the metal substrate with the particles of metal oxide catalyst. The method may include processing the metal substrate to increase surface area prior to coating the metal substrate with the particles of metal oxide catalyst. The processing steps may include etching, oxidation and reduction, mechanical roughening, electroless plating, electrodeposition, electrochemical sintering, thermal sintering, intentional dendritic formation via electrodeposition, or any combination thereof. The method may include depositing conductive particles onto the substrate prior to coating the metal substrate with the particles of metal oxide catalyst. The deposited conductive particles may be microscale conductive particles and mesoscale conductive particles. The method may include depositing a metal onto the substrate after depositing the conductive particles and prior to coating the metal substrate with the particles of metal oxide catalyst. The metal may be nickel. The particles of metal oxide catalyst may be mesoscale particles of metal oxide catalyst and nanoscale particles of metal oxide catalyst. The particles of metal oxide catalyst may be particles of cobalt or manganese. In some embodiments, the metal and/or metal oxide catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In some embodiments, a heat treatment in a controlled atmosphere (such as forming gas) is also applied.

The performance of any electrode or section of electrode operating at oxygen evolution reduction potentials hinges on high surface area and/or high porosity metallic substrates to provide ample reaction sites for OER. There may be many synthesis routes to high surface area metallic substrates. One method of engineering the pore size of an iron substrate to an acceptable size is through swelling. In some embodiments the substrate is made of a different starting metal. Iron ore can be caused to swell upon reduction in the appropriate reducing gas conditions, atmosphere (such as CO), flow rate, temperature, etc and/or with the proper pellet chemistry and additives (such as limestone). Swelling leads to a more open structure, and hence higher surface area and lower probability of pore clogging upon subsequent deposition of catalyst materials. Similarly, other metals, such as silver, have been shown to swell upon sintering. In some embodiments, powdered iron, fines, or crushed DRI are engineered to swell in the appropriate sinter conditions, possibly with the presence of a volatile additive that helps build local pressure, preventing the atoms from densifying. In either case, whether the swelling occurs during reduction or sintering, the processes ultimately increase the porosity of the metal structure without jeopardizing the mechanical integrity.

Additional methods of synthesizing highly porous, high surface area, controlled porosity metallic substrates for OER may be used in various embodiments. In various embodiments, a metallic OER substrate (typically iron) is produced using roll compaction or high shear roll compaction. Iron powders or similar materials are held together using binders, then pressed using rollers (which may also apply a heat treatment). The pressed green part is then sintered to create mechanical stability and electrical conductivity between iron particles. Selection of iron powder, fugitive pore formers and binders influence final surface area and porosity. In various embodiments, a metallic OER substrate (typically iron) is produced using cold isostatic pressing (CIP) then sliced into the appropriate size electrode. In various embodiments, a metallic OER substrate (typically iron) is produced using loose powder sintering, where no pressure to compact the iron powder is applied.

In various embodiments, a metallic OER substrate (typically iron) may be produced using one or more of various methods. For example, embodiment methods may generate Fe substrates with controlled pore size and surface area using combinations of particle sizes, pore formers, sulfides, oxides, carbides, then oxidizing and reducing heat treatments.

Iron-based materials exhibiting enhanced porosity may be fabricated by use of particulate materials processing techniques. One technique of introducing porosity during particulate materials processing is to introduce a fugitive phase. In one aspect, iron materials reduced using a rotary or linear hearth process (RHF or LHF, respectively) commonly use coal-based reductants, which also act as fugitive pore formers. Materials produced according to these processes may have advantageous properties when used in an iron electrode for a storage battery (a battery may also be referred to herein as an electrochemical cell). Other methods of introducing fugitive phases and forming iron-based materials via low-cost reduction techniques are also described. In some cases, the iron-based material may be reduced electrochemically inside the battery assembly, rather than thermochemically reduced during a processing step before introduction into the battery. In various embodiments, the iron electrode of a battery (or electrochemical cell) may be the negative electrode of the battery (or electrochemical cell).

Iron-based materials for input into a reduction process may be produced at very low cost from iron precursor pellets. Such iron precursor pellets may, for example, be formed by techniques used in for the manufacture of oxide pellets for blast furnaces and oxide pellets for direct reduction. During the pelletizing process, a fugitive phase may be introduced to the mixture which undergoes agglomeration, thereby providing a homogenous mixture of the fugitive phase with the other constituents within the pellet. Such an approach is useful in that it takes advantage of the large scale and low costs of pelletizing processes used in e.g. the steel industry. The pellets produced by such processes are usually roughly spherical and can range in size from several millimeters to several tens of millimeters. The radius of the pellets may be selected to yield desired kinetics for the reduction process, or desired mass and electrical transfer characteristics when used as an electrode in an energy storage device. An example of a fugitive phase being introduced into the mixture used in agglomeration is the introduction of coke into the pellets used in rotary hearth furnaces.

The iron-based material may also be made into sheets rather than pellets. These sheets may be produced by extrusion or doctor blading of iron precursor material into sheets. The mixture used in the sheet production process may contain a fugitive phase. In one example, magnetite ore concentrate mixed with coke may be doctor bladed into a thickness of approximately 5 mm and subsequently reduced in a linear hearth furnace. In another case, the sheet may be cut into strips and subsequently fed onto a rotary hearth furnace. The thickness of the sheet may be selected to yield desired kinetics for the reduction process, or desired mass and electrical transfer characteristics when used as an electrode in an energy storage device.

Other geometries may be possible for the iron-based material, including rods, discs, or plates. These geometries can in general be formed by techniques for the formation of green bodies in the particulate materials processing art including roll compaction of sheets, pressing and slip casting of plates, and extrusion to create rods and discs. Discs may result from extrusion when a circular die is used and the resulting material is cut to shape after exiting the die, from die compaction, or from slip casting into a cylindrical mold.

In some cases, the geometric shape which results from the reduction process may be subsequently broken up into small pieces. In one example, pellets from a direct reduction process possessing diameters on the order of 10 mm (mm=10⁻³ m) may be crushed after the reduction step such that the particle size is substantially refined to a particle size between 1 mm and 6 mm after the crushing process.

In one aspect, the iron-containing materials may be reduced by decomposition of a carbon-containing materials contained within the precursor material or distributed adjacent to the precursor material. This may occur by solid-state reduction with coal, coke, or other carbon-containing materials as occurs in rotary hearth furnaces used for the production of direct reduced iron. In other reduction processes involving carbon-containing materials, the carbon-containing material is distributed adjacent to the iron-containing material and reduction occurs via gas-phase transfer of reducing species from the carbon-containing material to the iron-containing material. For example, coal may be thermally decomposed in the presence of oxygen to yield a variety of reducing species including methane, hydrogen, and carbon monoxide. Any of the processes used in rotary kiln reduction processes or rotary hearth reduction processes should be considered applicable to the reduction of the iron-containing materials, including coal gasification wherein the coal is not strictly next to the iron-containing materials but is still used as a reductant.

Iron-containing materials may also be reduced via reaction with gas-phase reductants. There are many ways of introducing such reducing gases. One may split out these many ways of performing the reduction with gaseous constituents according to the machinery used to create the reducing process (and into sub-categories of batch and continuous processes). The processes may also be thought of in terms of the atmospheres which they use. Any suitable machinery may be used to create the reducing atmosphere and the types of reducing gases. Despite the great variety of such processes, the commonalities between all of them is that the processes generally require temperatures above at least 400° C. (usually substantially higher) and a continuous refreshing of the gas atmosphere in order to attain reasonable reduction kinetics and reasonable completion of the reduction reaction. The amount of time needed will in general depend on many factors (including the starting material, desired final reduced state, particle size, powdered body thickness, etc.), but typical conditions range from 700° C. to 1450° C. and 15 minutes to 3 hours at peak temperature.

In another aspect, the iron-containing materials may be electrochemically reduced. This may occur in an alkaline electrolyte, often with a pH above 12. Current collection and conductors through the pore space may be provided to allow the electrochemical process to occur successfully. Reduction outside of alkaline media may also be performed. The reduction may occur inside the same electrochemical cell that is used for electrochemical energy storage.

A fugitive phase may be used to create pore space (i.e. act as a pore former) inside a powdered compact. The essential requirement of a fugitive phase which acts as a pore former is to hold a volume open inside a powdered body until a point in the processing of the powdered body the powdered body attains sufficient mechanical integrity that the pore former may be removed and some of the volume left by the pore former remains as a pore. That is, a pore former may be used to increase the porosity of the material into which it is added. As different powdered bodies attain sufficient mechanical integrity at various points during processing, the means by which one introduces pore formers and the means by which one removes the pore former from the powdered body may be a function of the processing applied to the powdered body. In what follows, several methods of introducing pore formers are introduced. First, the pore formers themselves are introduced based on when/how they enter and leave the powdered compact. Subsequently, geometric characteristics of the pore formers are described within the context of their application to the production of iron-containing electrodes for energy storage.

In general, the reduction of iron containing materials described previously may take place by either high temperature thermochemical reduction, or by lower temperature electrochemical reduction.

First, fugitive phase pore formers for high temperature reduction processes are described. There are at least three ways that one can introduce a pore former into a material produced by high temperature processing: 1) to remove the pore former prior to high temperature processing; 2) to remove the pore former during high temperature processing; 3) and to remove the pore former after high temperature processing. Functional characteristics and examples of each are described below.

In order to remove a pore former from a powdered body before high temperature processing, a pore former may be first introduced to the body, the body may be allowed to attain some strength, and then the pore former may be removed. In one example of this, a pore former may be introduced into the body that contains a binder material (often a water-soluble binding agent which sets when dried from water). After the binding material is allowed to set or otherwise strengthen the material, the powdered body may be processed in such a manner that the pore former is removed. To give a concrete example, a pore former may be any material soluble in an organic solvent (i.e. paraffin wax in hexane), the porous body may be iron ore using a cement (for example, bentonite, sodium carbonate, calcium chloride, or sodium silicate) as a binder, and after the pellet has dried, the pore former may be dissolved by exposing the porous body to the organic solvent which dissolves the pore former while not altering the binder. In a second example, an iron ore porous body may use cement as a binder, and the binder, upon drying, may set and become insoluble in water. As such, a pore former that dissolves in water (for example, sodium chloride or any other water-soluble salt) may be removed from the pellet by re-exposure of the pellet to water. The pore former may also be a metal carbonate such as sodium carbonate or calcium carbonate (e.g., ground limestone), which dissolve in mild acidic solutions leaving pores. In a final example, a solid pore forming material may be added to the porous body which is inert during the process of forming the porous body but is easily evaporated during subsequent processing. For example, ammonium bicarbonate may be added to a compacted magnetite ore body, the compaction being sufficient to impart sufficient mechanical integrity to the porous body that the ammonium bicarbonate may be removed from the porous body via evaporation while some of the volume previously occupied by the ammonium bicarbonate is retained as pores. This evaporation may occur at low temperatures (˜36-41° C.) and may be accomplished prior to high temperature processing.

Materials may also be added which are removed during the high temperature processing steps. There are two such steps which often occur during the processing of iron-containing precursor materials. The first step is a preprocessing step which occurs prior to many reduction processes and after the formation of blast furnace and direct reduction pellets termed induration. During this process, pellets or other powdered bodies are oxidized at high temperatures. Through this oxidation process, the materials also gain mechanical integrity. Coke or other materials which evaporate in the presence of high temperatures may be added to powdered bodies in order to act as fugitive pore formers. Polymers, wood fiber, and carbonaceous materials produced by torrefaction may all be added as a means of inducing porosity during induration. It should be noted that not all materials need to be indurated prior to reduction, and thus that this step is not strictly necessary in the processing path.

During the high temperature reduction process, the powdered body is exposed to gases, usually carbon monoxide and hydrogen, which reduce the iron-containing materials. Materials that have a propensity to dramatically change volume upon exposure to such atmospheres may be added to iron-containing powdered bodies as a means of enhancing the porosity of the resulting materials. For example, iron sulfides and sulfates are not traditionally included in iron precursor material mixtures as inputs to reduction processes. However, in the specific case of iron alkaline electrodes these iron-sulfur compounds can serve multiple useful purposes. First, sulfur has been shown to be a useful compound in iron electrodes for promoting higher discharge capacities. Second, the iron sulfides and sulfates have very high ratios of the molar volume of the compound to the molar volume of the iron formed upon decomposition. Thus, these iron-sulfur compounds may act as pore formers upon loss of sulfur and oxygen due to these large reductions in volume. An especially inexpensive and effective pore former in this regard is iron (II) sulfate, which has a ratio of the volume of the sulfate to the volume of the iron upon reduction of 5.9-to-1 in the anhydrous state, with even larger volume ratios observed for the hydrated compound. Iron (II) sulfate is a byproduct of the steelmaking pickling process and may be usefully recycled in this manner to introduce a pore forming agent which introduces residual iron and sulfur as byproducts of the pore formation process. Other sulfides and sulfates of iron may be similarly used as fugitive phases which deposit iron and sulfur including, but not limited to, iron (II,II) sulfate, mackinawite, marcasite, pyrite, troilite, pyrrhotite, greigite, and amorphous iron (II) sulfide

Given that some materials may undergo useful phase transformations upon exposure to oxygen and subsequent reduction, other compounds may be usefully introduced to iron-containing materials which undergo induration and subsequent reduction. In one aspect, lead sulfide may be ground into a fine particulate and introduced as part of the iron-containing material mixture prior to an induration process. During the induration process, the lead sulfide may be roasted to form lead oxide. It should be noted that the melting point and boiling point of lead sulfide are both low relative to typical induration temperatures for iron oxide pellets. In order to retain the lead in the pellets, the induration procedure may need to be run at temperatures substantially below the boiling point of the lead sulfide (generally at least 20° C.), and preferably even below the melting point of the lead sulfide. Higher oxygen concentrations and longer times at temperature may be needed to achieve the same degree of induration when compared to higher temperature induration processes. The degree to which the liquid lead affects microstructural development will in general be a function of the various constituents in the iron pellets.

The lead oxide may be subsequently reduced to form lead metal distributed homogeneously with the pore space of the iron body. Lead is a known inhibitor of the hydrogen evolution reaction which competes with the charging processes for iron electrodes. Thus, inclusion of lead sulfide in an iron-containing precursor material may lead to the simultaneous formation of a pore and inclusion of a useful compound in the resulting battery electrode.

Materials may act as pore formers in the iron-containing material after the reduction process by dissolution. A limited set of materials are stable after reduction at temperatures that often exceed 700° C. in hydrogen. In one embodiment, silica may be included which may dissolve in the alkaline electrolyte. In another embodiment, sodium silicate (also known as water glass) may dissolve in an aqueous solution after the reduction process. In other embodiments, silicates such as quartz, feldspar, mica, amphibole, pyroxene, or olivine may be incorporated as soluble fugitive pore formers. Basic oxides which are stable through the reduction processes, such as sodium oxide, calcium oxide, or magnesium oxide, may be easily etched out of the iron skeleton via an acid after the reduction process (although such oxides may also dissolve in alkaline solution). In some embodiments, the basic oxide may be first added as a metal salt such as a sulfate, a carbonate, or a hydroxide, whereupon thermal decomposition to the oxide provides a first reduction in volume that increases the porosity. Optionally, the basic oxide may subsequently be removed by dissolution for a further increase in porosity. As an example, calcium carbonate in the form of limestone, or dolomite (calcium-magnesium carbonate), or calcium hydroxide or magnesium hydroxide, will each thermally decompose at temperatures in the range of 500-1100 degrees centigrade leaving their respective oxides.

Finally, for electrodes wherein the reduction is to happen electrochemically, pore formers may be chosen such that they dissolve in the electrolyte. In one aspect, the pore former may be a salt which is a component of the electrolyte. By way of illustration, a component of an alkaline electrolyte for iron batteries may be potassium or sodium hydroxide. A pore former made from potassium hydroxide may save costs by acting as both electrolyte additive and a pore former. In another aspect, the pore former may be a substance that is inert during electrochemical processing, such as ammonium nitrate or potassium sulfate.

In certain embodiments, the fugitive pore former may be the reducing agent in the conversion of iron ore (a more oxidized material) to iron metal. In certain other embodiments, the fugitive pore former may be itself reduced in the reduction step. In certain other embodiments, multiple pore formers, including combinations and variations of pore formers, serving as reducing agents or not participating in the reduction reactions may be used.

The geometric relationship between the pore former and the other elements of the microstructure play an important role in determining the optimal pore former size and volume fraction. Two general regimes may be distinguished. In one regime, the performance of the battery is limited by the amount of porosity immediately surrounding the iron. In this regime, the optimal pore former particle size is approximately the same as the particle size of the iron precursor particles input into the reduction process. In this regime, approximately matching the pore former size to the or particle size permits the porosity added through pore former addition to be most homogeneously distributed and with a minimal amount of porosity which is not directly adjacent to a reacting iron surface. Directly adjacent may be defined as being within one average pore radius from an iron surface. In cases where the pore former particles are not approximately equiaxed, the short axis of the pore former is should be approximately matched to the diameter of the iron ore particles.

In a second regime, the performance of the battery is limited by mass transport through the anode due to filling of the pore space. In this regime, the goal of introducing a pore former is to create a pore that is sufficiently large that it will not fill with discharge product such that the pore can act as a highly diffusive pathway through the microstructure. In this regime, the pore former should have a particle size exceeding twice the thickness of the layer of the discharge product that can be observed on the surface of the reacted iron surface. In this manner, the pores should be able to stay open after formation of the discharge product and facilitate mass transport through the electrode. In cases where the pore former is not approximately equiaxed, the short axis of the pore former should obey the guidance of being at least twice the thickness of the layer of the discharge product. In cases where one desires to create diffusive paths through the porous body which will not clog, the aspect ratio of the pore former will lead to different percolation thresholds of the residual porosity at different aspect ratios. High aspect ratio rods will percolate at the lowest volume fraction in randomly assembled porous bodies, potentially permitting the highest gain in diffusive kinetics at the lowest volume fraction of pore former (and therefore the lowest added cost. In general for the second regime, there is likely to be diminishing returns to performance in pore former additions above approximately 30-35 vol. % of pore former (where the pore former volume fraction is expressed as a percentage of the solids added to the porous body) due to the high porosities attained after reduction and the high likelihood of percolation of the resultant porosity. Nonetheless, in related electrode systems, a higher volume fraction of pore formers has been demonstrated to exert some benefit on battery performance as quantified by an increase in the discharge capacity of the battery. The pore former volume fraction may in some embodiments be up to 45 vol. % while still having benefits for increased anode capacity. While high pore former volume fractions are generally beneficial for some aspects of battery performance, bounds may be placed on the volume fraction of the pore former according to where reasonable increases in performance are observed, and in some instances where the pore-forming agent is effective as a reducing agent during a reducing process. In many circumstances, at least 5 vol. % of the pore former is needed in order to gain substantial increases in battery performance and to realize sufficient gains in performance. In the case of coke added to magnetite ores, one may instead use a weight percentage basis to quantify the amount of pore forming additive included. In the case of coke added to magnetite ores, a weight percentage of coke between 3 to 10 wt. % is generally sufficient to achieve the desired combination of pore forming and reduction.

Pore formers which are much larger than the limits discussed (e.g., about twice the discharge layer thickness and about the average particle size) are likely to impart less improvements to performance relative to finer pore formers on an equivalent-volume basis. In all cases, as the volume fraction of the pore former increases, mass transport becomes more facile and polarization due to mass transport is reduced, while the effective conductivity of the porous body is reduced, as is the volumetric energy density of the electrode. The optimal amount of pore former can be guided via impedance measurements and measurements of the dominant source of impedance in the system and considerations around the required energy density of the system. There is a tradeoff around porosity in that increasing porosity will improve ion transport (kinetics) but will decrease the energy density per unit volume; this tradeoff implies that for a given rate, there will be an optimal porosity to maximize energy density.

In general, adding pore formers much finer than to particle size of the input iron-containing materials is unlikely to result in a substantial increase in porosity, although it may result in other positive process characteristics (e.g. more effective reduction and faster reduction kinetics in rotary heart reduction processes).

In some electrode configurations, combinations of the above effects may be used to produce a superposition of the desired effects. For example, a fine, equiaxed pore former on the order of the particle size may be added to increase the accessible volume for the formation of discharge product and a larger, high aspect ratio fiber-like pore former may be added to enhance mass transport through the porous body.

In general, pore forming agents may be usefully combined when their various roles are complementary. In one illustrative example, coke may be added to perform a solid state reduction process of iron-containing precursors, but too much added coke may result in undesirably high carbon contents after the reduction process. In circumstances where a higher amount of pore former is desired than can be added without resulting in undesirably high carbon contents, a second pore forming additive may be added in addition to the coke to supply a pore forming function without adding additional carbon, while the coke level is maintained at a level sufficient to accomplish the desired reduction reaction.

The sources for iron-containing materials may be any of the materials commonly used in either iron electrodes or industrial iron reductions processes. The particle sizes of the iron precursor materials may be selected based on the particle sizes inherent to upstream processes used to produce the iron ore source, based on the particle size needed to successfully reduce the iron ore source during the appropriate reduction process applied, or based on the resulting iron electrode material achieving sufficient performance during electrochemical cycling. Generally, fine ore particles are desired for both reduction processes and electrochemical performance, with successful particle sizes prior to reduction being below d₉₀<45 microns for magnetite-based ores for battery discharge timescales of around 10 hours. (d_{N} is the particle diameter corresponding to the Nth percentile in a particle size distribution. For example, d₉₀ means the 90th percentile of particle size distribution, or stated differently, that 90% of particles in a given distribution have a size below d₉₀. This could be measured by a dynamic light scattering method, imaging, or other methods known in the art). Other particle sizes are possible based on the reduction process and electrochemical process applied, with longer reduction times and lower electrochemical charge/discharge rates permitting the use of larger particle sizes. For batteries where much high rate capability is needed, an iron precursor size may be needed, with precursor sizes with a d₅₀ of ˜8 microns being desired. The desire for fineness of the incoming iron precursor materials is generally balanced by cost considerations related to performing more intensive grinding operations.

Various embodiments include a bifunctional air electrode, comprising: a metal substrate; and particles of metal oxide catalyst and/or metal nitride catalyst deposited on the metal substrate. In various embodiments, the metal substrate is a mesh, a foam, or a porous sintered solid. In various embodiments, the metal substrate comprises iron, nickel, iron-alloy, copper, aluminum, steel, carbon steel, or stainless steel. In various embodiments, the particles of metal oxide catalyst and/or metal nitride catalyst comprise manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof. In various embodiments, the metal substrate comprises nickel rich iron alloy. In various embodiments, the electrode further comprises particles of metal deposited on the metal substrate. In various embodiments, the particles of metal comprise iron or nickel. In various embodiments, the metal substrate comprises iron, the particles of metal comprise nickel, and the particles of metal oxide catalyst comprise manganese oxide; the metal substrate comprises nickel, the particles of metal comprise iron, and the particles of metal oxide catalyst comprise manganese oxide; the metal substrate comprises steel, the particles of metal comprise nickel, and the particles of metal oxide catalyst comprise manganese oxide; the metal substrate comprises steel, the particles of metal comprise iron, and the particles of metal oxide catalyst comprise manganese oxide; the metal substrate comprises carbon steel, the particles of metal comprise nickel, and the particles of metal oxide catalyst comprise manganese oxide; the metal substrate comprises carbon steel, the particles of metal comprise iron, and the particles of metal oxide catalyst comprise manganese oxide; the metal substrate comprises stainless steel, the particles of metal comprise nickel, and the particles of metal oxide catalyst comprise manganese oxide; or the metal substrate comprises stainless steel, the particles of metal comprise iron, and the particles of metal oxide catalyst and/or metal nitride catalyst comprise manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}MnᵥO₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof. In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments include a bifunctional air electrode, comprising: a first portion configured to engage an oxygen reduction reaction (ORR) in a discharge mode; and a second portion configured to engage an oxygen evolution reaction (OER) in a charge mode. In various embodiments, the first portion comprises an ORR electrode and an ORR catalyst; and the second portion comprises an OER electrode and an OER catalyst. In various embodiments, the ORR electrode comprises carbon cloth, carbon felt, carbon paper, or a gas diffusion layer; the ORR catalyst comprises silver, palladium, platinum, manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓ₋Co₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof; the OER electrode comprises nickel, iron, stainless steel, or carbon steel; and the OER catalyst comprises metallic nickel, metallic iron, manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof. In various embodiments, the ORR electrode and/or the OER electrode is a mesh, a foam, or a porous sintered solid. In various embodiments, the electrode further comprises a hydrophobic coating on one or both of either of the first portion and the second portion. In various embodiments, the hydrophobic coating comprises polyethylene, polyvinylidene fluoride, polytetrafluoroethylene, or polypropylene. In various embodiments, the ORR electrode comprises a carbon substrate coated with a manganese oxide catalyst. In various embodiments, the carbon substrate is a carbon cloth, a carbon felt, a carbon paper, or a gas diffusion layer. In various embodiments, the OER electrode comprises a metal substrate. In various embodiments, the metal substrate comprises titanium, nickel, iron, stainless steel, or carbon steel. In various embodiments, the metal substrate is coated with catalyst comprising silver, palladium, platinum, manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}MnᵥO₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, metallic nickel, metallic iron, one or more metal nitrides, Fe₃N, FeCN, ZrN, Mn₄N, or any combinations thereof. In various embodiments, the metal substrate comprises direct reduced iron (DRI), atomized iron powder, or sponge iron. In various embodiments, the metal substrate comprises a mesh, a foam, a sintered porous structure, or a packed bed of metal particles. In various embodiments, the metal substrate comprises a packed bed of particles comprising direct reduced iron (DRI) or sponge iron. In various embodiments, the metal substrate is in the form of a cage configured to operate as a current collector and having openings configured for electrolyte and gas flow. In various embodiments, the cage comprises iron, nickel, or a nickel-iron alloy. In various embodiments, the cage is coated with a catalyst comprising silver, palladium, platinum, manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, metallic nickel, metallic iron, one or more metal nitrides, Fe₃N, FeCN, ZrN, Mn₄N, or any combinations thereof. In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments include a method for making an air electrode, the method comprising coating a metal substrate with particles of metal oxide catalyst and/or metal nitride catalyst. In various embodiments, the metal oxide catalyst and/or metal nitride catalyst comprises manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}MnᵥO₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof. In various embodiments, coating the metal substrate with the particles of metal oxide catalyst and/or metal nitride catalyst comprises electrodepositing or electroplating the particles of metal oxide catalyst and/or metal nitride catalyst onto the metal substrate in an acid solution. In various embodiments, the method may further comprise depositing a metallic layer on the substrate prior to coating the metal substrate with the particles of metal oxide catalyst and/or metal nitride catalyst. In various embodiments, the method may further comprise processing the metal substrate to increase surface area prior to coating the metal substrate with the particles of metal oxide catalyst and/or metal nitride catalyst. In various embodiments, the processing steps may include etching, oxidation and reduction, mechanical roughening, electroless plating, electrodeposition, electrochemical sintering, thermal sintering, intentional dendritic formation via electrodeposition, or any combination thereof. In various embodiments, the method may further comprise depositing conductive particles onto the substrate prior to coating the metal substrate with the particles of metal oxide catalyst and/or metal nitride catalyst. In various embodiments, the deposited conductive particles are microscale conductive particles and mesoscale conductive particles. In various embodiments, the method may further comprise depositing a metal onto the substrate after depositing the conductive particles and prior to coating the metal substrate with the particles of metal oxide catalyst and/or metal nitride catalyst. In various embodiments, the metal is nickel. In various embodiments, the particles of metal oxide catalyst and/or metal nitride catalyst are mesoscale particles of metal oxide catalyst and/or metal nitride catalyst and nanoscale particles of metal oxide catalyst and/or metal nitride catalyst. In various embodiments, the metal oxide catalyst and/or metal nitride catalyst comprises manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}MnᵥO₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, one or more metal nitrides, Fe₃N, FeCN, ZrN, Mn₄N, or any combinations thereof. In various embodiments, the particles of metal oxide catalyst are particles of cobalt or manganese. In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments may include a battery, comprising: a first vessel; a bifunctional air electrode; a metal electrode; and a first volume of liquid electrolyte within the first vessel, wherein the first volume of liquid electrolyte separates the bifunctional air electrode from the metal electrode. In various embodiments, the battery may further comprise a switch coupled to an electrical lead; a charge lead coupled between the switch and a first portion of the bifunctional air electrode, the first portion configured to engage an oxygen reduction reaction (ORR) when the battery is operated in a discharging mode; and a discharge lead coupled to between the switch and a second portion of the bifunctional air electrode, the second portion configured to engage an oxygen evolution reaction (OER) when the battery is operated in a charging mode, wherein the switch is configured to selectively electrically connect the electrical lead to either the charge lead or the discharge lead. In various embodiments, the first portion of the bifunctional air electrode is physically separated from the second portion of the bifunctional air electrode. In various embodiments, the first portion of the bifunctional air electrode is positioned at an interface between air and the first volume of liquid electrolyte in the first vessel; and the second portion of the bifunctional air electrode is submerged in the first volume of liquid electrolyte. In various embodiments, the size of the first portion of the bifunctional air electrode is different than the size of the second portion of the bifunctional air electrode. In various embodiments, the bifunctional air electrode floats on the first volume of liquid electrolyte while engaging in an oxygen reduction reaction (ORR) and submerges in the first volume of liquid electrolyte while engaging in an oxygen evolution reaction (OER). In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments may include a battery, comprising: a vessel; an oxygen reduction reaction (ORR) air electrode; an oxygen evolution reaction (OER) electrode; a metal electrode; and a first volume of liquid electrolyte within the vessel, wherein the first volume of liquid electrolyte separates the ORR air electrode and the OER electrode from the metal electrode. In various embodiments, the battery may further comprise a first separator disposed in the vessel between the ORR air electrode and the metal electrode; and a second separator disposed in the vessel between the OER electrode and the metal electrode. In various embodiments, the ORR air electrode is positioned at an interface between air and the first volume of liquid electrolyte and the OER electrode is submerged in the first volume of liquid electrolyte. In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments may include a bulk energy storage system, comprising: one or more batteries, wherein at least one of the one or more batteries comprises: a first vessel; a bifunctional air electrode comprising: a first portion configured to engage an oxygen reduction reaction (ORR) when the battery is operated in a discharging mode; and a second portion configured to engage an oxygen evolution reaction (OER) when the battery is operated in a charging mode; a metal electrode; and a first volume of liquid electrolyte within the first vessel, wherein the first volume of liquid electrolyte separates the bifunctional air electrode from the metal electrode. In various embodiments, the bifunction air electrode further comprises: a metal substrate; and particles of metal oxide catalyst and/or metal nitride catalyst deposited on the metal substrate. In various embodiments, the particles of metal oxide catalyst and/or metal nitride catalyst comprise, manganese oxide (MnO₂, Mn₂O₃, Mn₃O₄, MnₓO_{y} nickel-doped manganese oxide (Ni—MnₓO_{y}), nickel oxide (NiOₓ), nickel oxyhydroxide (NiOₓ(OH)_{y}), iron oxide (FeOₓ), iron oxyhydroxide (FeOₓ(OH)_{y}), cobalt oxide (Co₃O₄, CoₓO_{y}), manganese cobalt oxide (MnCo₂O₄, Mn₁₊ₓCo₂₋ₓO₄), cobalt manganese oxide (CoMn₂O₄), nickel manganese oxide (NiMnOₓ), manganese iron oxide (MnFe₂O₄, Mn₁₊ₓFe₂₋ₓO₄), nickel-doped manganese oxide (Ni—MnₓO_{y}), manganese cobalt iron oxide (MnₓCo_{y}Fe_{z}O₄), zinc cobalt manganese oxide (ZnCoMnO₄, ZnₓCo_{y}Mn_{z}O₄), cobalt nickel oxide (CoNiOₓ), calcium manganese oxide (CaMnOₓ), lanthanum manganese oxide (LaMnO₃), lanthanum cobalt oxide (LaCo₂O₄, La₁₊ₓCo₂₋ₓO₄), lanthanum nickel oxide (LaNiO₃), lanthanum calcium aluminum manganese oxide (LaₓCa_{y}Al_{z}Mn_{y}O₃), nickel iron oxide (Ni_{z}Fe_{1-z}Oₓ), manganese ferrite (MnFe₂O₄), zinc ferrite (ZnFe₂O₄), nickel cobaltite (NiCo₂O₄), lanthanum strontium manganate (La_{0.8}Sr_{0.2}MnO₃), other transition metal oxides, Fe₃N, FeCN, ZrN, Mn₄N, other metal nitrides, or any combinations thereof. In various embodiments, the bulk energy storage system is a long duration energy storage (LODES) system. In various embodiments, the metal oxide catalyst and/or metal nitride catalyst is a metal nitride catalyst prepared by reacting Fe₂O₃ or Fe₃O₄ with ammonia in a furnace or reaction vessel. In various embodiments, the metal oxide catalyst and/or metal nitride catalyst is Fe₃C. In various embodiments, the metal nitride catalyst is prepared by reacting Fe₃C with ammonia in a furnace or reaction vessel. In various embodiments, the metal oxide catalyst and/or metal nitride catalyst is deposited using chemical vapor deposition (CVD), atomic layer deposition (ALD), thermal evaporation, sputtering, spray pyrolysis, solution-based deposition, hot dip coating, or inkjet printing, or some combination thereof. In various embodiments, a heat treatment in a controlled atmosphere is also applied. In various embodiments, the metal substrate is porous and based on metal powder including but not limited to nickel powder, nickel coated stainless steel powder, nickel coated carbon steel, cobalt, cobalt coated stainless steel, cobalt coated carbon steel, or combinations thereof. In various embodiments, the binder materials are included in the metal powder based porous substrates. In various embodiments, the binder materials comprise polyethylene (PE), polypropylene (PP), polyvinylidene fluoride (PVDF), polytetrafluoroethylene (PTFE), or combinations thereof.

Various embodiments may provide devices and/or methods for use in bulk energy storage systems, such as long duration energy storage (LODES) systems, short duration energy storage (SDES) systems, etc. As an example, various embodiments may provide batteries (e.g., batteries 100, 400, 450, 500, etc.) for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

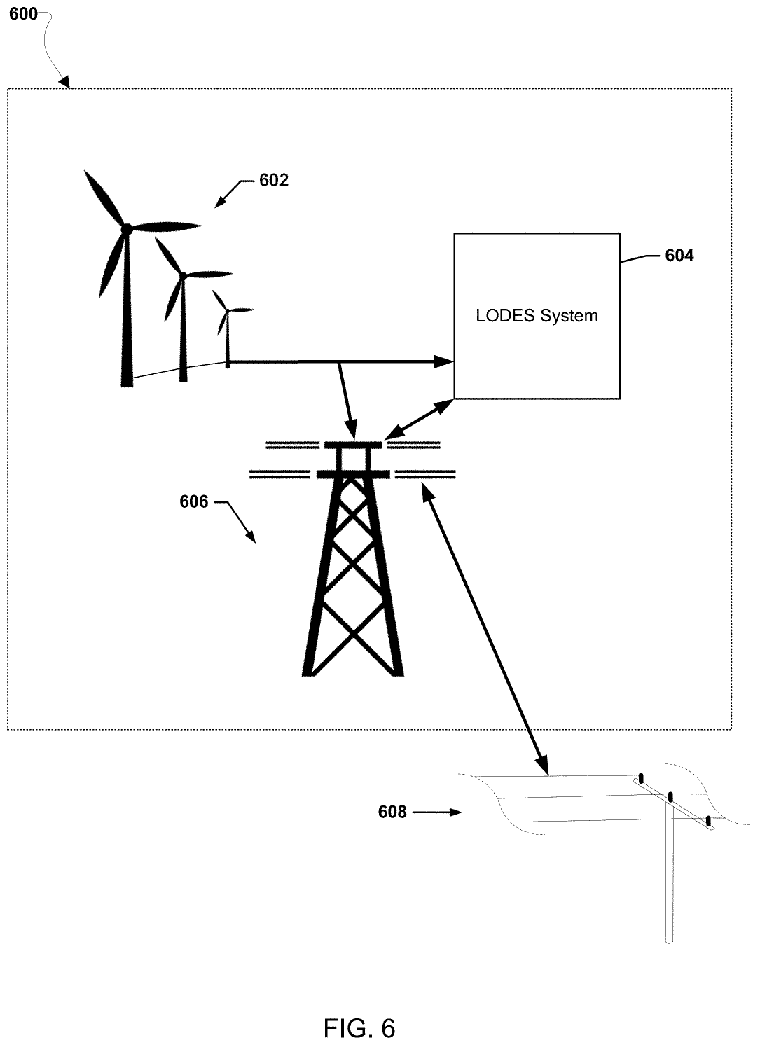

FIGS. 6-14 illustrate various example systems in which one or more aspects of the various embodiments may be used as part of bulk energy storage systems, such as LODES systems, SDES systems, etc. For example, various embodiment batteries described herein (e.g., batteries 100, 400, 450, 500, etc.) may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 6 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be electrically connected to a wind farm 602 and one or more transmission facilities 606. The wind farm 602 may be electrically connected to the transmission facilities 606. The transmission facilities 606 may be electrically connected to the grid 608. The wind farm 602 may generate power and the wind farm 602 may output generated power to the LODES system 604 and/or the transmission facilities 606. The LODES system 604 may store power received from the wind farm 602 and/or the transmission facilities 606. The LODES system 604 may output stored power to the transmission facilities 606. The transmission facilities 606 may output power received from one or both of the wind farm 602 and LODES system 604 to the grid 608 and/or may receive power from the grid 608 and output that power to the LODES system 604. Together the wind farm 602, the LODES system 604, and the transmission facilities 606 may constitute a power plant 600 that may be a combined power generation, transmission, and storage system. The power generated by the wind farm 602 may be directly fed to the grid 608 through the transmission facilities 606, or may be first stored in the LODES system 604. In certain cases the power supplied to the grid 608 may come entirely from the wind farm 602, entirely from the LODES system 604, or from a combination of the wind farm 602 and the LODES system 604. The dispatch of power from the combined wind farm 602 and LODES system 604 power plant 600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 600, the LODES system 604 may be used to reshape and “firm” the power produced by the wind farm 602. In one such example, the wind farm 602 may have a peak generation output (capacity) of 260 megawatts (MW) and a capacity factor (CF) of 41%. The LODES system 604 may have a power rating (capacity) of 106 MW, a rated duration (energy/power ratio) of 150 hours (h), and an energy rating of 15,900 megawatt hours (MWh). In another such example, the wind farm 602 may have a peak generation output (capacity) of 300 MW and a capacity factor (CF) of 41%. The LODES system 604 may have a power rating of 106 MW, a rated duration (energy/power ratio) of 200 h and an energy rating of 21,200 MWh. In another such example, the wind farm 602 may have a peak generation output (capacity) of 176 MW and a capacity factor (CF) of 53%. The LODES system 604 may have a power rating (capacity) of 88 MW, a rated duration (energy/power ratio) of 150 h and an energy rating of 13,200 MWh. In another such example, the wind farm 602 may have a peak generation output (capacity) of 277 MW and a capacity factor (CF) of 41%. The LODES system 604 may have a power rating (capacity) of 97 MW, a rated duration (energy/power ratio) of 50 h and an energy rating of 4,850 MWh. In another such example, the wind farm 602 may have a peak generation output (capacity) of 315 MW and a capacity factor (CF) of 41%. The LODES system 604 may have a power rating (capacity) of 110 MW, a rated duration (energy/power ratio) of 25 h and an energy rating of 2,750 MWh.

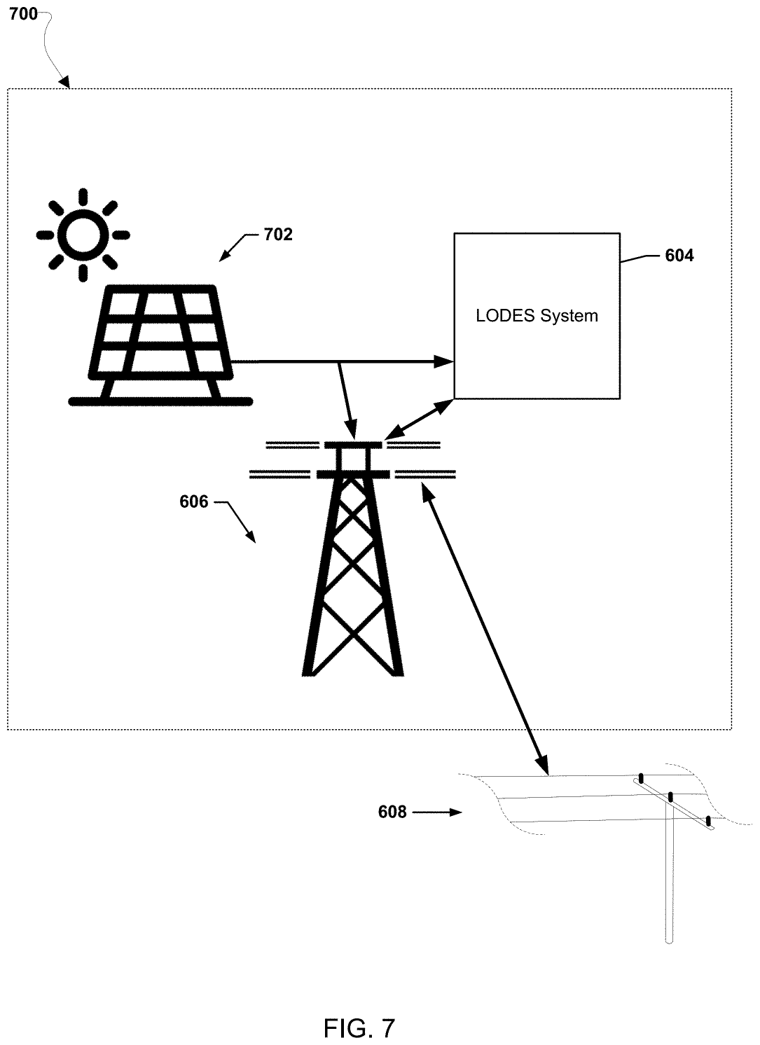

FIG. 7 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The system of FIG. 7 may be similar to the system of FIG. 6, except a photovoltaic (PV) farm 702 may be substituted for the wind farm 602. The LODES system 604 may be electrically connected to the PV farm 702 and one or more transmission facilities 606. The PV farm 702 may be electrically connected to the transmission facilities 606. The transmission facilities 606 may be electrically connected to the grid 608. The PV farm 702 may generate power and the PV farm 702 may output generated power to the LODES system 604 and/or the transmission facilities 606. The LODES system 604 may store power received from the PV farm 702 and/or the transmission facilities 606. The LODES system 604 may output stored power to the transmission facilities 606. The transmission facilities 606 may output power received from one or both of the PV farm 702 and LODES system 604 to the grid 608 and/or may receive power from the grid 608 and output that power to the LODES system 604. Together the PV farm 702, the LODES system 604, and the transmission facilities 606 may constitute a power plant 700 that may be a combined power generation, transmission, and storage system. The power generated by the PV farm 702 may be directly fed to the grid 608 through the transmission facilities 606, or may be first stored in the LODES system 604. In certain cases the power supplied to the grid 608 may come entirely from the PV farm 702, entirely from the LODES system 604, or from a combination of the PV farm 702 and the LODES system 604. The dispatch of power from the combined PV farm 702 and LODES system 604 power plant 700 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 700, the LODES system 604 may be used to reshape and “firm” the power produced by the PV farm 702. In one such example, the PV farm 702 may have a peak generation output (capacity) of 490 MW and a capacity factor (CF) of 24%. The LODES system 604 may have a power rating (capacity) of 340 MW, a rated duration (energy/power ratio) of 150 h and an energy rating of 51,000 MWh. In another such example, the PV farm 702 may have a peak generation output (capacity) of 680 MW and a capacity factor (CF) of 24%. The LODES system 604 may have a power rating (capacity) of 410 MW, a rated duration (energy/power ratio) of 200 h, and an energy rating of 82,000 MWh. In another such example, the PV farm 702 may have a peak generation output (capacity) of 330 MW and a capacity factor (CF) of 31%. The LODES system 604 may have a power rating (capacity) of 215 MW, a rated duration (energy/power ratio) of 150 h, and an energy rating of 32,250 MWh. In another such example, the PV farm 702 may have a peak generation output (capacity) of 510 MW and a capacity factor (CF) of 24%. The LODES system 604 may have a power rating (capacity) of 380 MW, a rated duration (energy/power ratio) of 50 h, and an energy rating of 19,000 MWh. In another such example, the PV farm 702 may have a peak generation output (capacity) of 630 MW and a capacity factor (CF) of 24%. The LODES system 604 may have a power rating (capacity) of 380 MW, a rated duration (energy/power ratio) of 25 h, and an energy rating of 9,500 MWh.

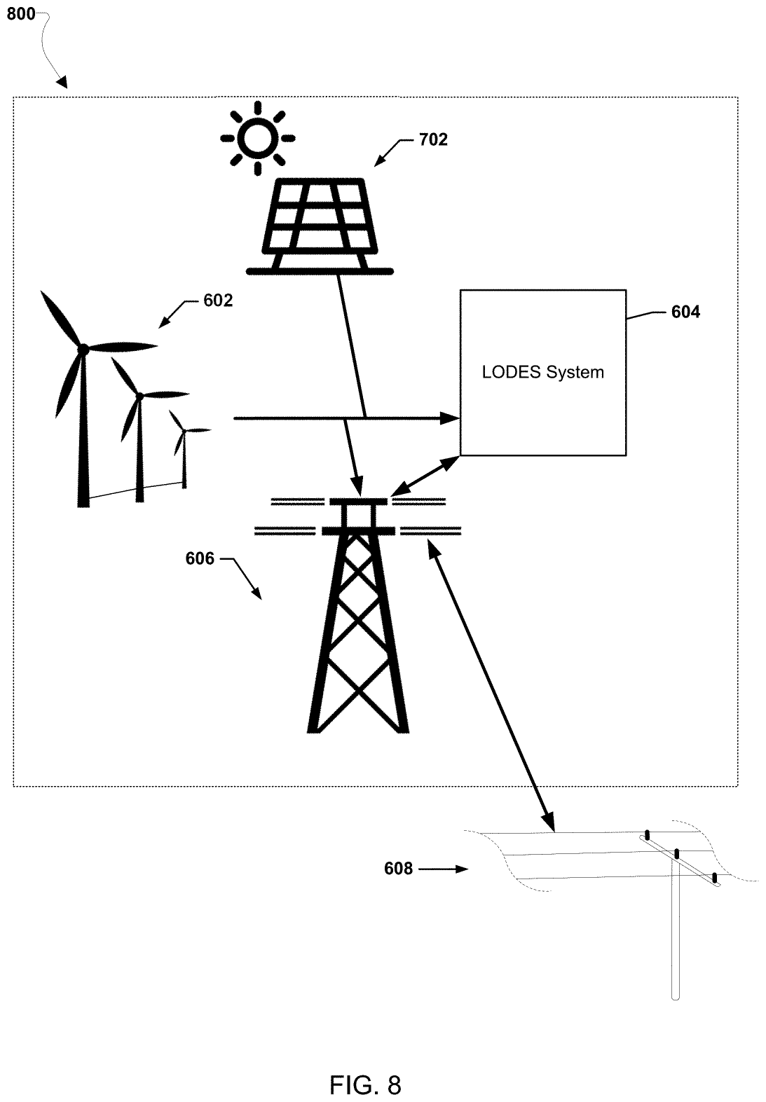

FIG. 8 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The system of FIG. 8 may be similar to the systems of FIGS. 6 and 7, except the wind farm ‘602 and the photovoltaic (PV) farm 702 may both be power generators working together in the power plant 800. Together the PV farm 702, wind farm 602, the LODES system 604, and the transmission facilities 606 may constitute the power plant 800 that may be a combined power generation, transmission, and storage system. The power generated by the PV farm 702 and/or the wind farm 602 may be directly fed to the grid 608 through the transmission facilities 606, or may be first stored in the LODES system 604. In certain cases the power supplied to the grid 608 may come entirely from the PV farm 702, entirely from the wind farm 602, entirely from the LODES system 604, or from a combination of the PV farm 702, the wind farm 602, and the LODES system 604. The dispatch of power from the combined wind farm 602, PV farm 702, and LODES system 604 power plant 800 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 800, the LODES system 604 may be used to reshape and “firm” the power produced by the wind farm 602 and the PV farm 702. In one such example, the wind farm 602 may have a peak generation output (capacity) of 126 MW and a capacity factor (CF) of 41% and the PV farm 702 may have a peak generation output (capacity) of 126 MW and a capacity factor (CF) of 24%. The LODES system 604 may have a power rating (capacity) of 63 MW, a rated duration (energy/power ratio) of 150 h, and an energy rating of 9,450 MWh. In another such example, the wind farm 602 may have a peak generation output (capacity) of 170 MW and a capacity factor (CF) of 41% and the PV farm 702 may have a peak generation output (capacity) of 110 MW and a capacity factor (CF) of 24%. The LODES system 604 may have a power rating (capacity) of 57 MW, a rated duration (energy/power ratio) of 200 h, and an energy rating of 11,400 MWh. In another such example, the wind farm 602 may have a peak generation output (capacity) of 105 MW and a capacity factor (CF) of 51% and the PV farm 702 may have a peak generation output (capacity) of 70 MW and a capacity factor (CF) of 31 The LODES system 604 may have a power rating (capacity) of 61 MW, a rated duration (energy/power ratio) of 150 h, and an energy rating of 9,150 MWh. In another such example, the wind farm 602 may have a peak generation output (capacity) of 135 MW and a capacity factor (CF) of 41% and the PV farm 702 may have a peak generation output (capacity) of 90 MW and a capacity factor (CF) of 24%. The LODES system 604 may have a power rating (capacity) of 68 MW, a rated duration (energy/power ratio) of 50 h, and an energy rating of 3,400 MWh. In another such example, the wind farm 602 may have a peak generation output (capacity) of 144 MW and a capacity factor (CF) of 41% and the PV farm 702 may have a peak generation output (capacity) of 96 MW and a capacity factor (CF) of 24%. The LODES system 604 may have a power rating (capacity) of 72 MW, a rated duration (energy/power ratio) of 25 h, and an energy rating of 1,800 MWh.

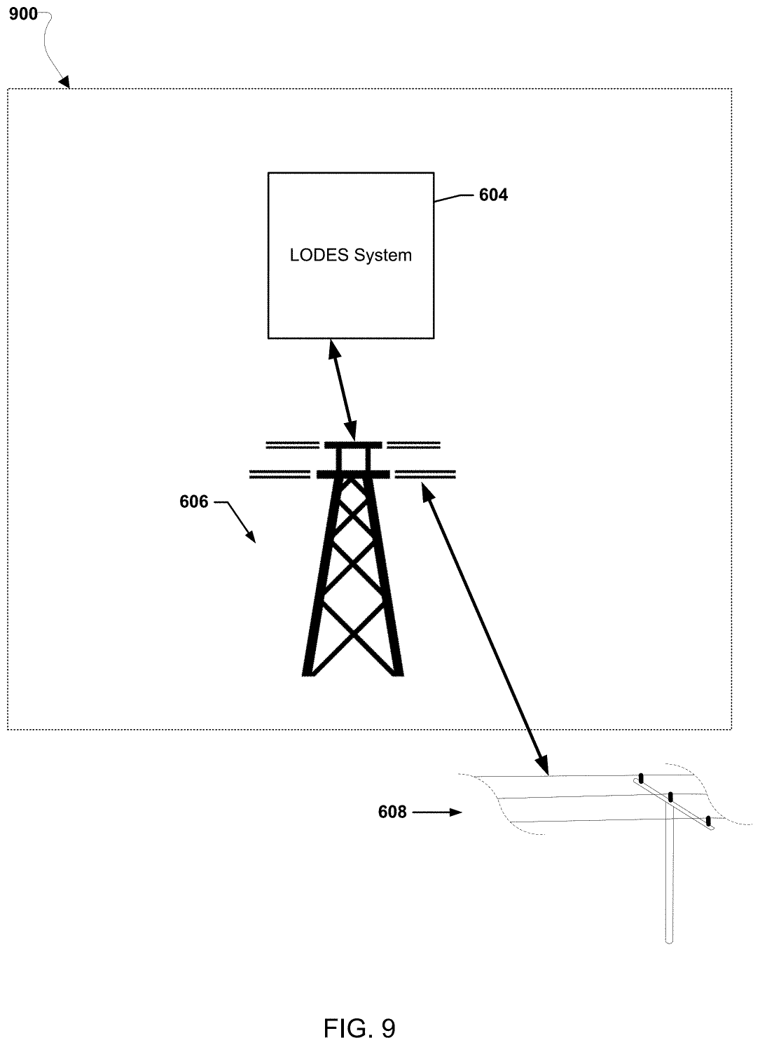

FIG. 9 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be electrically connected to one or more transmission facilities 606. In this manner, the LODES system 604 may operate in a “stand-alone” manner to arbiter energy around market prices and/or to avoid transmission constraints. The LODES system 604 may be electrically connected to one or more transmission facilities 606. The transmission facilities 606 may be electrically connected to the grid 608. The LODES system 604 may store power received from the transmission facilities 606. The LODES system 604 may output stored power to the transmission facilities 606. The transmission facilities 606 may output power received from the LODES system 604 to the grid 608 and/or may receive power from the grid 608 and output that power to the LODES system 604.

Together the LODES system 604 and the transmission facilities 606 may constitute a power plant 900. As an example, the power plant 900 may be situated downstream of a transmission constraint, close to electrical consumption. In such an example downstream situated power plant 900, the LODES system 604 may have a duration of 24 h to 500 h and may undergo one or more full discharges a year to support peak electrical consumptions at times when the transmission capacity is not sufficient to serve customers. Additionally in such an example downstream situated power plant 900, the LODES system 604 may undergo several shallow discharges (daily or at higher frequency) to arbiter the difference between nighttime and daytime electricity prices and reduce the overall cost of electrical service to customer. As a further example, the power plant 900 may be situated upstream of a transmission constraint, close to electrical generation. In such an example upstream situated power plant 900, the LODES system 604 may have a duration of 24 h to 500 h and may undergo one or more full charges a year to absorb excess generation at times when the transmission capacity is not sufficient to distribute the electricity to customers. Additionally in such an example upstream situated power plant 900, the LODES system 604 may undergo several shallow charges and discharges (daily or at higher frequency) to arbiter the difference between nighttime and daytime electricity prices and maximize the value of the output of the generation facilities.

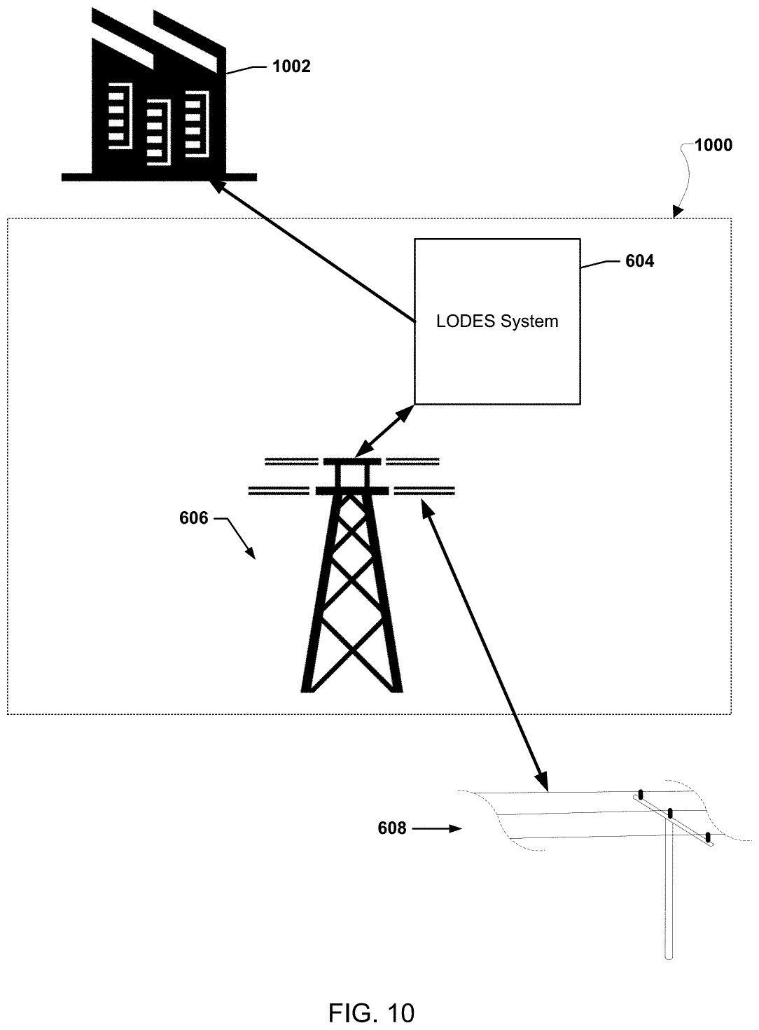

FIG. 10 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be electrically connected to a commercial and industrial (C&I) customer 1002, such as a data center, factory, etc. The LODES system 604 may be electrically connected to one or more transmission facilities 606. The transmission facilities 606 may be electrically connected to the grid 608. The transmission facilities 606 may receive power from the grid 608 and output that power to the LODES system 604. The LODES system 604 may store power received from the transmission facilities 606. The LODES system 604 may output stored power to the C&I customer 1002. In this manner, the LODES system 604 may operate to reshape electricity purchased from the grid 608 to match the consumption pattern of the C&I customer 1002.

Together, the LODES system 604 and transmission facilities 606 may constitute a power plant 1000. As an example, the power plant 1000 may be situated close to electrical consumption, i.e., close to the C&I customer 1002, such as between the grid 608 and the C&I customer 1002. In such an example, the LODES system 604 may have a duration of 24 h to 500 h and may buy electricity from the markets and thereby charge the LODES system 604 at times when the electricity is cheaper. The LODES system 604 may then discharge to provide the C&I customer 1002 with electricity at times when the market price is expensive, therefore offsetting the market purchases of the C&I customer 1002. As an alternative configuration, rather than being situated between the grid 608 and the C&I customer 1002, the power plant 1000 may be situated between a renewable source, such as a PV farm, wind farm, etc., and the transmission facilities 606 may connect to the renewable source. In such an alternative example, the LODES system 604 may have a duration of 24 h to 500 h, and the LODES system 604 may charge at times when renewable output may be available. The LODES system 604 may then discharge to provide the C&I customer 1002 with renewable generated electricity so as to cover a portion, or the entirety, of the C&I customer 1002 electricity needs.

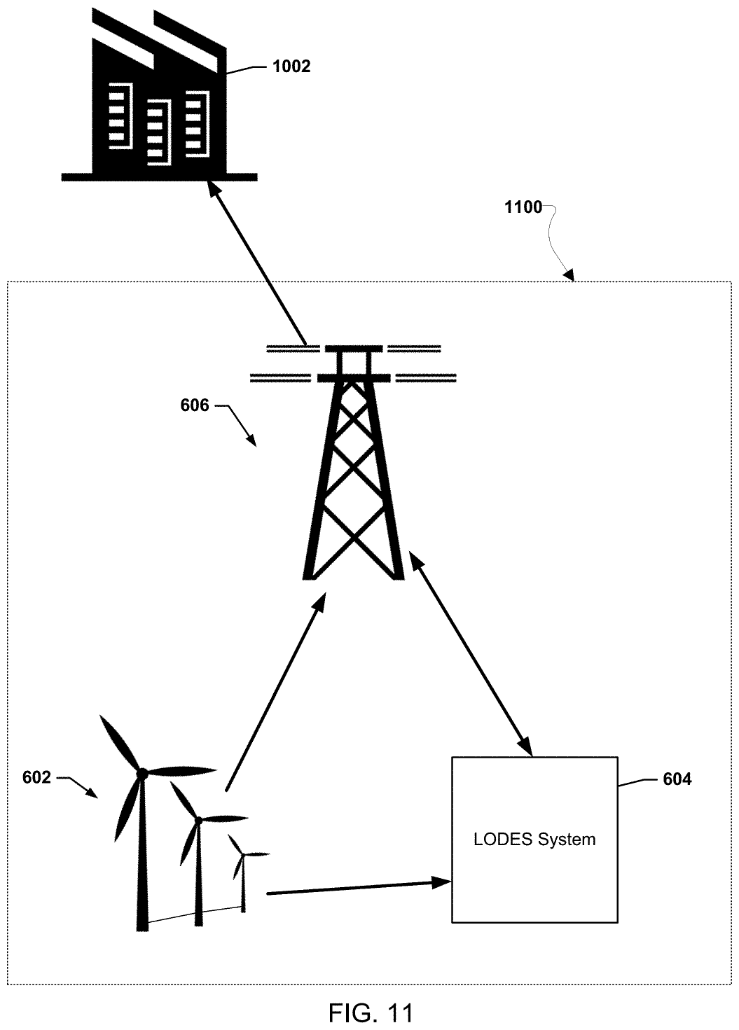

FIG. 11 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be electrically connected to a wind farm 602 and one or more transmission facilities 606. The wind farm 602 may be electrically connected to the transmission facilities 606. The transmission facilities 606 may be electrically connected to a C&I customer 1002. The wind farm 602 may generate power and the wind farm 602 may output generated power to the LODES system 604 and/or the transmission facilities 606. The LODES system 604 may store power received from the wind farm 602.

The LODES system 604 may output stored power to the transmission facilities 606. The transmission facilities 606 may output power received from one or both of the wind farm 602 and LODES system 604 to the C&I customer 1002. Together the wind farm 602, the LODES system 604, and the transmission facilities 606 may constitute a power plant 1100 that may be a combined power generation, transmission, and storage system. The power generated by the wind farm 602 may be directly fed to the C&I customer 1002 through the transmission facilities 606, or may be first stored in the LODES system 604. In certain cases the power supplied to the C&I customer 1002 may come entirely from the wind farm 602, entirely from the LODES system 604, or from a combination of the wind farm 602 and the LODES system 604. The LODES system 604 may be used to reshape the electricity generated by the wind farm 602 to match the consumption pattern of the C&I customer 1002. In one such example, the LODES system 604 may have a duration of 24 h to 500 h and may charge when renewable generation by the wind farm 602 exceeds the C&I customer 1002 load. The LODES system 604 may then discharge when renewable generation by the wind farm 602 falls short of C&I customer 1002 load so as to provide the C&I customer 1002 with a firm renewable profile that offsets a fraction, or all of, the C&I customer 1002 electrical consumption.

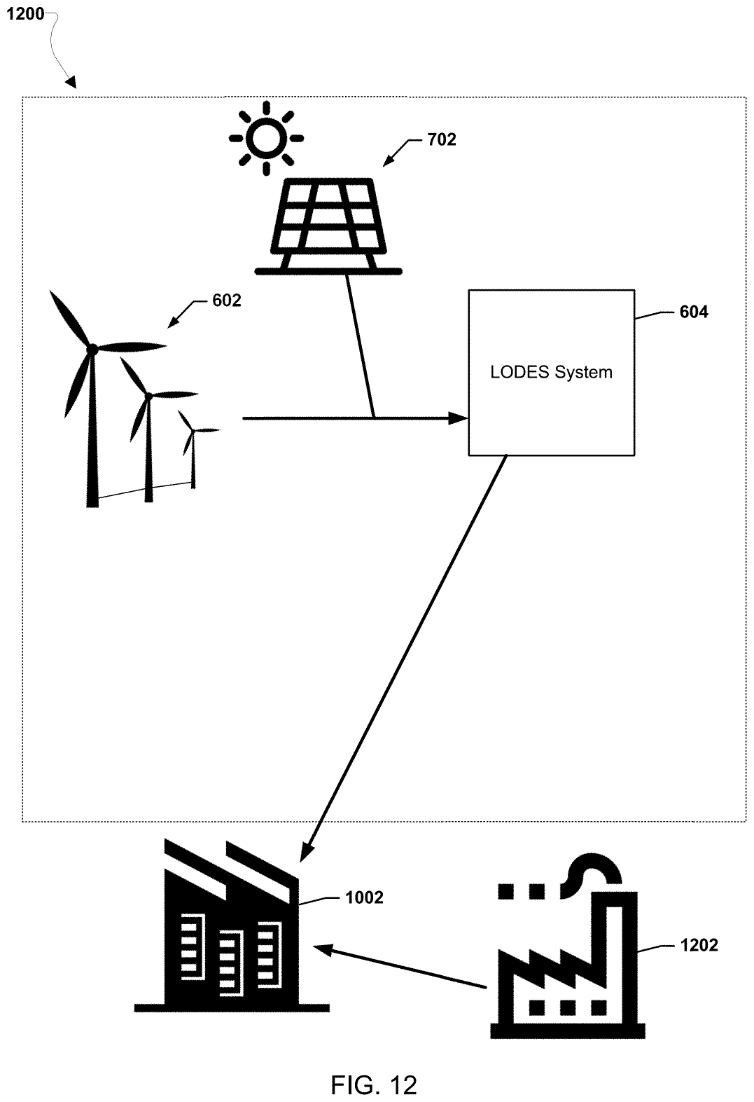

FIG. 12 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be part of a power plant 1200 that is used to integrate large amounts of renewable generation in microgrids and harmonize the output of renewable generation by, for example a PV farm 702 and wind farm 602, with existing thermal generation by, for example a thermal power plant 1202 (e.g., a gas plant, a coal plant, a diesel generator set, etc., or a combination of thermal generation methods), while renewable generation and thermal generation supply the C&I customer 1002 load at high availability. Microgrids, such as the microgrid constituted by the power plant 1200 and the thermal power plant 1202, may provide availability that is 90% or higher. The power generated by the PV farm 702 and/or the wind farm 602 may be directly fed to the C&I customer 1002, or may be first stored in the LODES system 604.

In certain cases the power supplied to the C&I customer 1002 may come entirely from the PV farm 702, entirely from the wind farm 602, entirely from the LODES system 604, entirely from the thermal power plant 1202, or from any combination of the PV farm 702, the wind farm 602, the LODES system 604, and/or the thermal power plant 1202. As examples, the LODES system 604 of the power plant 1200 may have a duration of 24 h to 500 h. As a specific example, the C&I customer 1002 load may have a peak of 100 MW, the LODES system 604 may have a power rating of 14 MW and duration of 150 h, natural gas may cost $6/million British thermal units (MMBTU), and the renewable penetration may be 58%. As another specific example, the C&I customer 1002 load may have a peak of 100 MW, the LODES system 604 may have a power rating of 25 MW and duration of 150 h, natural gas may cost 8/MMBTU, and the renewable penetration may be 65%.

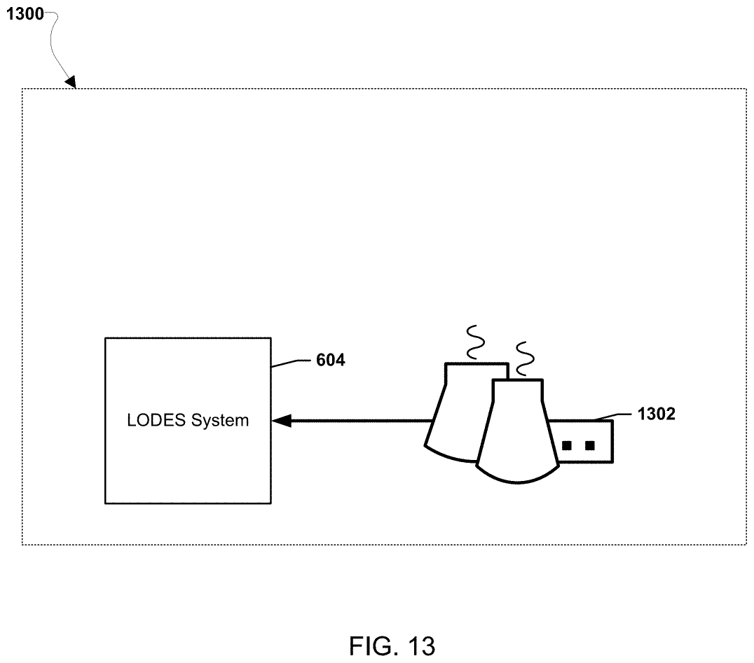

FIG. 13 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may be used to augment a nuclear plant 1302 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1300 constituted by the combined LODES system 604 and nuclear plant 1302. The nuclear plant 1302 may operate at high capacity factor and at the highest efficiency point, while the LODES system 604 may charge and discharge to effectively reshape the output of the nuclear plant 1302 to match a customer electrical consumption and/or a market price of electricity. As examples, the LODES system 604 of the power plant 1300 may have a duration of 24 h to 500 h. In one specific example, the nuclear plant 1302 may have 1,000 MW of rated output and the nuclear plant 1302 may be forced into prolonged periods of minimum stable generation or even shutdowns because of depressed market pricing of electricity. The LODES system 604 may avoid facility shutdowns and charge at times of depressed market pricing; and the LODES system 604 may subsequently discharge and boost total output generation at times of inflated market pricing.

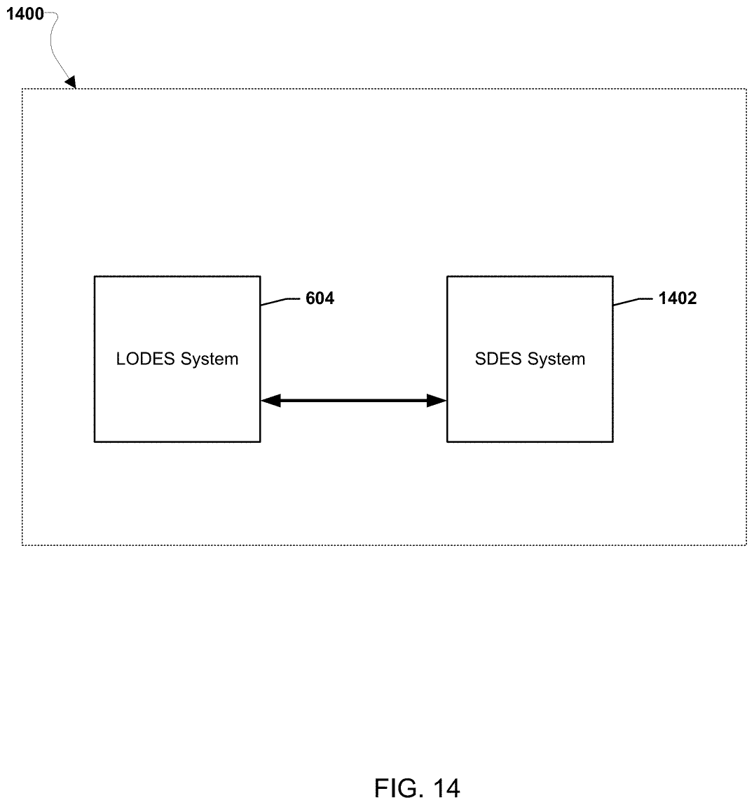

FIG. 14 illustrates an example system in which one or more aspects of the various embodiments may be used as part of bulk energy storage system. As a specific example, the bulk energy storage system incorporating one or more aspects of the various embodiments may be a LODES system 604. As an example, the LODES system 604 may include various embodiment batteries described herein (e.g., batteries 100, 400, 450, 500, etc.), various electrodes described herein, etc. The LODES system 604 may operate in tandem with a SDES system 1402. Together the LODES system 604 and SDES system 1402 may constitute a power plant 1400. As an example, the LODES system 604 and SDES system 1402 may be co-optimized whereby the LODES system 604 may provide various services, including long-duration back-up and/or bridging through multi-day fluctuations (e.g., multi-day fluctuations in market pricing, renewable generation, electrical consumption, etc.), and the SDES system 1402 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1402 may have durations of less than 10 hours and round-trip efficiencies of greater than 80%. The LODES system 604 may have durations of 24 h to 500 h and round-trip efficiencies of greater than 40%. In one such example, the LODES system 604 may have a duration of 150 hours and support customer electrical consumption for up to a week of renewable under-generation. The LODES system 604 may also support customer electrical consumption during intra-day under-generation events, augmenting the capabilities of the SDES system 1402. Further, the SDES system 1402 may supply customers during intra-day under-generation events and provide power conditioning and quality services such as voltage control and frequency regulation.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A bifunctional air electrode, comprising:
a metal substrate; and
particles deposited on the metal substrate, wherein the particles comprise particles of metal oxide catalyst, particles of metal nitride catalyst, or a combination thereof.

2. The electrode of claim 1, wherein the metal substrate is a mesh, a foam, or a porous sintered solid.

3. The electrode of claim 1, wherein the metal substrate comprises iron, nickel, an iron-alloy, copper, aluminum, steel, or any combination thereof.

4. The electrode of claim 1, wherein either or both of the particles of metal oxide catalyst and the particles of metal nitride catalyst comprise manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, a transition metal oxide, a metal nitrides, Fe₃C, or any combinations thereof.

5. The electrode of claim 4, wherein the metal substrate comprises nickel rich iron alloy.

6. The electrode of claim 5, further comprising particles of metal deposited on the metal substrate.

7. The electrode of claim 6, wherein the particles of metal comprise iron, nickel, steel, or combinations thereof.

8. The electrode of claim 1, further comprising particles of metal deposited on the metal substrate.

9. The electrode of claim 8, wherein:
the metal substrate comprises iron, nickel, or combinations thereof;
the particles of metal comprise iron, nickel, or combinations thereof; and
the particles of metal oxide catalyst comprise manganese oxide.

10. The electrode of claim 8, wherein:
the metal substrate comprises steel;
the particles of metal comprise iron, nickel, or combinations thereof; and
the particles of metal oxide catalyst comprise manganese oxide.

11. The electrode of claim 1, wherein the metal substrate comprises a metal powder.

12. The electrode of claim 11, wherein the metal powder comprises nickel powder, nickel coated stainless steel powder, nickel coated carbon steel powder, cobalt powder, cobalt coated stainless steel powder, cobalt coated carbon steel powder, or combinations thereof.

13. The electrode of claim 11, wherein the metal powder includes binder materials therein.

14. The electrode of claim 13, wherein the binder materials comprise polyethylene (PE), polypropylene (PP), polyvinylidene fluoride (PVDF), polytetrafluoroethylene (PTFE), or combinations thereof.

15. A bifunctional air electrode, comprising:
a first portion configured to engage an oxygen reduction reaction (ORR) in a discharge mode; and
a second portion configured to engage an oxygen evolution reaction (OER) in a charge mode.

16. The electrode of claim 15, wherein:
the first portion comprises an ORR electrode and an ORR catalyst; and
the second portion comprises an OER electrode and an OER catalyst.

17. The electrode of claim 16, wherein:
the ORR electrode comprises carbon cloth, carbon felt, carbon paper, or a gas diffusion layer; and
the OER electrode comprises nickel, iron, stainless steel, or carbon steel.

18. The electrode of claim 17, wherein the ORR catalyst comprises silver, palladium, platinum, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, Fe₃C, or any combinations thereof.

19. The electrode of claim 17, wherein the OER catalyst comprises metallic nickel, metallic iron, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, Fe₃C, or any combinations thereof.

20. The electrode of claim 16, wherein one or both of the ORR electrode and the OER electrode comprises a mesh, a foam, or a porous sintered solid.

21. The electrode of claim 15, further comprising a hydrophobic coating on one or both of either of the first portion and the second portion.

22. The electrode of claim 21, wherein the hydrophobic coating comprises polyethylene, polyvinylidene fluoride, polytetrafluoroethylene, polypropylene, or a combination thereof.

23. The electrode of claim 16, wherein the ORR electrode comprises a carbon substrate coated with a manganese oxide catalyst.

24. The electrode of claim 23, wherein the carbon substrate comprises a carbon cloth, a carbon felt, a carbon paper, or a gas diffusion layer.

25. The electrode of claim 16, wherein the OER electrode comprises a metal substrate.

26. The electrode of claim 25, wherein the metal substrate comprises titanium, nickel, iron, stainless steel, carbon steel, or combinations thereof.

27. The electrode of claim 26, wherein the metal substrate is coated with catalyst comprising silver, palladium, platinum, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, or any combinations thereof.

28. The electrode of claim 26, wherein the metal substrate comprises direct reduced iron (DRI), atomized iron powder, sponge iron, or combinations thereof.

29. The electrode of claim 26, wherein the metal substrate comprises a mesh, a foam, a sintered porous structure, or a packed bed of metal particles.

30. The electrode of claim 26, where the metal substrate comprises a packed bed of particles comprising direct reduced iron (DRI), sponge iron, or combinations thereof.

31. The electrode of claim 26, wherein the metal substrate is in the form of a cage configured to operate as a current collector and having openings configured for electrolyte and gas flow.

32. The electrode of claim 31, wherein the cage comprises iron, nickel, a nickel-iron alloy, or combinations thereof.

33. The electrode of claim 32, wherein the cage is coated with a catalyst comprising silver, palladium, platinum, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, or any combinations thereof.

34. The electrode of claim 25, wherein the metal substrate comprises a metal powder.

35. The electrode of claim 34, wherein the metal powder comprises nickel powder, nickel coated stainless steel powder, nickel coated carbon steel powder, cobalt powder, cobalt coated stainless steel powder, cobalt coated carbon steel powder, or combinations thereof.

36. The electrode of claim 34, wherein the metal powder includes binder materials therein.

37. The electrode of claim 36, wherein the binder materials comprise polyethylene (PE), polypropylene (PP), polyvinylidene fluoride (PVDF), polytetrafluoroethylene (PTFE), or combinations thereof.

38. A method for making an air electrode, the method comprising:
coating a metal substrate with particles,
wherein the particles of comprise particles of metal oxide catalyst, particles of metal nitride catalyst, or a combination thereof.

39. The method of claim 38, wherein either or both of the particles of metal oxide catalyst and the particles of metal nitride catalyst comprise manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, a transition metal oxide, a metal nitrides, Fe₃C, or any combinations thereof.

40. The method of claim 38, wherein coating the metal substrate with the particles comprises electrodepositing or electroplating the particles onto the metal substrate in an acid solution.

41. The method of claim 38, further comprising depositing a metallic layer on the metal substrate prior to coating the metal substrate with the particles.

42. The method of claim 38, further comprising processing the metal substrate to increase a surface area of the metal substrate prior to coating the metal substrate with the particles.

43. The method of claim 42, wherein the processing comprises etching, oxidation and reduction, mechanical roughening, electroless plating, electrodeposition, electrochemical sintering, thermal sintering, intentional dendritic formation via electrodeposition, or any combination thereof.

44. The method of claim 38, further comprising depositing conductive particles onto the metal substrate prior to coating the metal substrate with the particles.

45. The method of claim 44, wherein deposited conductive particles comprise microscale conductive particles and mesoscale conductive particles.

46. The method of claim 44, further comprising depositing a metal onto the metal substrate after depositing the conductive particles and prior to coating the metal substrate with the particles.

47. The method of claim 46, wherein the deposited metal comprises nickel.

48. The method of claim 42, wherein the particles coated onto the metal substrate comprise mesoscale particles and nanoscale particles.

49. The method of claim 48, wherein either or both of the particles of metal oxide catalyst and the particles of metal nitride catalyst comprise cobalt, managanese, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, Fe₃C, or any combinations thereof.

50. The method of claim 38, further comprising:
preparing the particles prior by reacting Fe₃C, Fe₂O₃, or Fe₃O₄ with ammonia in a furnace or reaction vessel.

51. The method of claim 38, wherein coating the metal substrate with the particles comprises coating the metal substrate with the particles using chemical vapor deposition (CVD), atomic layer deposition (ALD), thermal evaporation, sputtering, spray pyrolysis, solution-based deposition, hot dip coating, inkjet printing, or some combination thereof.

52. The method of claim 51, further comprising applying a heat treatment to the coated metal substrate in a controlled atmosphere.

53. A battery, comprising:
a first vessel;
a bifunctional air electrode;
a metal electrode; and
a first volume of liquid electrolyte within the first vessel, wherein the first volume of liquid electrolyte separates the bifunctional air electrode from the metal electrode.

54. The battery of claim 53, further comprising:
a switch coupled to an electrical lead;
a charge lead coupled between the switch and a first portion of the bifunctional air electrode, the first portion configured to engage an oxygen reduction reaction (ORR) when the battery is operated in a discharging mode; and
a discharge lead coupled to between the switch and a second portion of the bifunctional air electrode, the second portion configured to engage an oxygen evolution reaction (OER) when the battery is operated in a charging mode,
wherein the switch is configured to selectively electrically connect the electrical lead to either the charge lead or the discharge lead.

55. The battery of claim 54, wherein the first portion of the bifunctional air electrode is physically separated from the second portion of the bifunctional air electrode.

56. The battery of claim 55, wherein:
the first portion of the bifunctional air electrode is positioned at an interface between air and the first volume of liquid electrolyte in the first vessel; and
the second portion of the bifunctional air electrode is submerged in the first volume of liquid electrolyte.

57. The battery of claim 54, wherein the size of the first portion of the bifunctional air electrode is different than the size of the second portion of the bifunctional air electrode.

58. The battery of claim 53, wherein the bifunctional air electrode floats on the first volume of liquid electrolyte while engaging in an oxygen reduction reaction (ORR) and submerges in the first volume of liquid electrolyte while engaging in an oxygen evolution reaction (OER).

59. A battery, comprising:
a vessel;
an oxygen reduction reaction (ORR) air electrode;
an oxygen evolution reaction (OER) electrode;
a metal electrode; and
a first volume of liquid electrolyte within the vessel, wherein the first volume of liquid electrolyte separates the ORR air electrode and the OER electrode from the metal electrode.

60. The battery of claim 59, further comprising:
a first separator disposed in the vessel between the ORR air electrode and the metal electrode; and
a second separator disposed in the vessel between the OER electrode and the metal electrode.

61. The battery of claim 60, wherein the ORR air electrode is positioned at an interface between air and the first volume of liquid electrolyte and the OER electrode is submerged in the first volume of liquid electrolyte.

62. A bulk energy storage system, comprising:
one or more batteries, wherein at least one of the one or more batteries comprises:
a first vessel;
a bifunctional air electrode comprising:
a first portion configured to engage an oxygen reduction reaction (ORR) when the battery is operated in a discharging mode; and
a second portion configured to engage an oxygen evolution reaction (OER) when the battery is operated in a charging mode;
a metal electrode; and
a first volume of liquid electrolyte within the first vessel, wherein the first volume of liquid electrolyte separates the bifunctional air electrode from the metal electrode.

63. The bulk energy storage system of claim 62, wherein the bifunction air electrode further comprises:
a metal substrate; and
particles deposited on the metal substrate, wherein the particles comprise particles of metal oxide catalyst, particles of metal nitride catalyst, or a combination thereof.

64. The bulk energy storage system of claim 63, wherein either or both of the particles of metal oxide catalyst and the particles of metal nitride catalyst comprise cobalt, managanese, manganese oxide, nickel-doped manganese oxide, nickel oxide, nickel oxyhydroxide, iron oxide, iron oxyhydroxide, cobalt oxide, manganese cobalt oxide, cobalt manganese oxide, nickel manganese oxide, manganese iron oxide, nickel-doped manganese oxide, manganese cobalt iron oxide, zinc cobalt manganese oxide, cobalt nickel oxide, calcium manganese oxide, lanthanum manganese oxide, lanthanum cobalt oxide, lanthanum nickel oxide, lanthanum calcium aluminum manganese oxide, nickel iron oxide, manganese ferrite, zinc ferrite, nickel cobaltite, lanthanum strontium manganate, Fe₃N, FeCN, ZrN, Mn₄N, or any combinations thereof.

65. The bulk energy storage system of claim 64, wherein the bulk energy storage system is a long duration energy storage (LODES) system.

66. The bulk energy storage system of claim 64, wherein the metal substrate comprises a metal powder.

67. The bulk energy storage system of claim 66, wherein the metal powder comprises nickel powder, nickel coated stainless steel powder, nickel coated carbon steel powder, cobalt powder, cobalt coated stainless steel powder, cobalt coated carbon steel powder, or combinations thereof.

68. The bulk energy storage system of claim 66, wherein the metal powder includes binder materials therein.

69. The bulk energy storage system of claim 68, wherein the binder materials comprise polyethylene (PE), polypropylene (PP), polyvinylidene fluoride (PVDF), polytetrafluoroethylene (PTFE), or combinations thereof.
